(19) United States
(12) Patent Application Publication
(10) Pub. No.: US 2015/0195378 A1
(43) Pub. Date: Jul. 9, 2015

(54) INFORMATION PROCESSING APPARATUS, SERVER, INFORMATION PROCESSING METHOD, AND INFORMATION PROCESSING SYSTEM

(71) Applicant: Sony Corporation, Tokyo (JP)

(72) Inventors: Natsuki Kano, Tokyo (JP); Hideki Oyaizu, Tokyo (JP); Jun Kimura, Kanagawa (JP)

(73) Assignee: Sony Corporation, Tokyo (JP)

(21) Appl. No.: 14/413,353

(22) PCT Filed: Jul. 4, 2013
(86) PCT No.: PCT/JP2013/068416

§ 371 Date: Jan. 7, 2015

(30) Foreign Application Priority Data
Jul. 17, 2012 (JP) 2012-158310

(51) Int. Cl. H04L 29/06; G06F 17/30; H04L 29/08

(52) U.S. Cl. CPC H04L 67/42; H04L 67/10; G06F 17/30876

(57) ABSTRACT

The present technique relates to an information processing apparatus, a server, an information processing method, and an information processing system that can control electronic mail reception in accordance with an emotion or a state of a receiver.

A communication control unit receives main information transmitted from a sender, and sender information related to the emotion or the state of the sender at the time of the transmission of the main information. A data acquiring unit acquires receiver information related to the emotion or the state of a receiver. An analyzing unit analyzes the main information, the sender information, and the receiver information. A determining unit determines whether the main information is to be presented based on a result of the analysis carried out by the analyzing unit. The present technique can be applied to an information processing apparatus that is operated by a user and exchanges information with another apparatus being operated by another user.

### TECHNICAL FIELD

The present technique relates to information processing apparatuses, servers, information processing methods, and information processing systems, and more particularly, to an information processing apparatus, a server, an information processing method, and an information processing system that can control electronic mail reception in accordance with the emotion or the state of the receiver.

### BACKGROUND ART

In recent years, communication via electronic mail has become common (see Patent Documents 1 through 3, for example), and electronic mail is frequently exchanged. A typical method of receiving electronic mail is a push-type method. In the case of a push-type method, when electronic mail is transmitted from a sender, the electronic mail is immediately received by the receiver. Therefore, the receiver receives the electronic mail, regardless of his/her wishes.

To counter this problem, a receiver of mail normally designates specific senders from whom mail can be received and specific times at which mail can be received. In this manner, reception methods can be changed, or reception of certain mail can be rejected.

For example, Patent Document 1 discloses a technique of issuing an alert to the terminal of a receiver when a sender enters or exits a predetermined alert area.

Patent Document 2 discloses a technique of changing notification methods being used by a notifying unit based on the setting state of the notifying unit of the terminal on the receiving end, and on notification command information included in electronic mail.

### CITATION LIST

### Patent Document

Patent Document 1: JP 2001-14592 A

Patent Document 2: JP 2011-97302 A

Patent Document 3: JP 2011-131651 A

### SUMMARY OF THE INVENTION

### Problems to be Solved by the Invention

By the techniques disclosed in Patent Documents 1 and 2, however, electronic mail reception is controlled based on location information about the sender or information included in electronic mail, but is not controlled in accordance with an emotion or a state of the receiver.

Patent Document 3 discloses a technique by which the sender adds his/her emotion to mail prior to transmission. Even by this technique disclosed in Patent Document 3, however, only the emotion of the sender is displayed on the terminal of the receiver, and electronic mail reception is not controlled in accordance with an emotion or a state of the receiver.

Specifically, a receiver who is feeling down would like to avoid receiving mail consulting about a serious matter as much as possible, and a receiver who is under great stress would like to avoid receiving complaint mail as much as possible. However, by any of the conventional techniques disclosed in Patent Documents 1 through 3, emotions or states of receivers are not taken into consideration, and receivers end up receiving electronic mail even when they are in the above mentioned states.

The present technique has been developed in view of the above circumstances, and aims to control electronic mail reception in accordance with an emotion or a state of the receiver.

### Solutions to Problems

An information processing apparatus of a first aspect of the present technique includes: a receiving unit that receives main information transmitted from a sender, and sender information related to an emotion or a state of the sender at the time of the transmission of the main information; an acquiring unit that acquires receiver information related to an emotion or a state of a receiver; an analyzing unit that analyzes the main information, the sender information, and the receiver information; and a determining unit that determines whether the main information is to be presented based on a result of the analysis carried out by the analyzing unit.

The determining unit may determine a method of presenting the main information when having determined that the main information is to be presented, and determine a method of rejecting the main information when having determined that the main information is not to be presented.

The presentation method may include at least one of a method concerning the timing to present the main information, and a method concerning the site for storing the main information.

The analyzing unit may calculate a first score representing the sender information, and a second score representing the receiver information, the determining unit may determine whether the main information is to be presented based on a comparison between the first score and the second score.

The main information may be electronic mail or sound.

The sender information may include at least one of a result of detection performed by a sensor that detects a state of the sender, and an emotion status of the sender that is set based on an operation performed by the sender.

The receiver information may include at least one of a result of detection performed by a sensor that detects a state of the receiver, and an emotion status of the receiver that is set based on an operation performed by the receiver.

The result of the detection performed by the sensor may include physical information containing at least one of a body temperature, a heart rate, and a respiration rate, an image, or sound.

An information processing method of the first aspect of the present technique is an information processing method compatible with the above described information processing apparatus of the first aspect of the present technique.

In the first aspect of the present technique, main information transmitted from a sender, and sender information related to an emotion or a state of the sender at the time of the transmission of the main information are received; receiver information related to an emotion or a state of a receiver is acquired; the main information, the sender information, and the receiver information are analyzed; and whether the main information is to be presented is determined based on a result of the analysis.

A server of a second aspect of the present technique includes: a receiving unit that receives main information transmitted from a sender, sender information related to an emotion or a state of the sender at the time of the transmission of the main information, and pieces of receiver information related to emotions or states of receivers; and a transmitting unit that transmits the main information, and the sender information and the pieces of receiver information as information for determining whether the main information is to be presented, to the respective receivers.

The server may further include: a status setting unit that sets emotion statuses of the respective receivers based on the pieces of receiver information; and a determining unit that determines whether the main information is to be transmitted to the respective receivers based on the emotion statuses set by the status setting unit for the respective receivers. When the determining unit determines that the main information is to be transmitted, the transmitting unit does not transmit the sender information and the pieces of receiver information, and transmits only the main information to the receivers. When the determining unit determines that the main information is not to be transmitted, the transmitting unit does not transmit the main information, the sender information, and the pieces of receiver information.

The determining unit may determine a method of transmitting the main information to the receivers when having determined that the main information is to be transmitted, and determine a method of rejecting transmission of the main information to the receivers when having determined that the main information is not to be transmitted.

An information processing method of the second aspect of the present technique is an information processing method compatible with the above described information processing apparatus of the second aspect of the present technique.

In the second aspect of the present technique, main information transmitted from a sender, sender information related to an emotion or a state of the sender at the time of the transmission of the main information, and pieces of receiver information related to emotions or states of receivers are received; and the main information, and the sender information and the pieces of receiver information as information for determining whether the main information is to be presented, are transmitted to the respective receivers.

An information processing system of a third aspect of the present technique includes a transmission apparatus and a reception apparatus. The transmission apparatus includes: a first communication unit that transmits main information and sender information related to an emotion or a state of a sender at the time of the transmission of the main information. The reception apparatus includes: a second communication unit that receives the main information and the sender information transmitted from the transmission apparatus; an acquiring unit that acquires receiver information related to an emotion or a state of a receiver; an analyzing unit that analyzes the main information, the sender information, and the receiver information; and a determining unit that determines whether the main information is to be presented based on a result of the analysis carried out by the analyzing unit.

An information processing method of the third aspect of the present technique is an information processing method compatible with the above described information processing system of the third aspect of the present technique.

In the third aspect of the present technique, at a transmission apparatus in an information processing system including the transmission apparatus and a reception apparatus, main information and sender information related to an emotion or a state of a sender at the time of the transmission of the main information are transmitted. At the reception apparatus, the main information and the sender information transmitted from the transmission apparatus are received; receiver information related to an emotion or a state of a receiver is acquired; the main information, the sender information, and the receiver information are analyzed; and whether the main information is to be presented is determined based on a result of the analysis.

An information processing system of a fourth aspect of the present technique includes a transmission apparatus, reception apparatuses, and a server. The transmission apparatus includes a first communication unit that transmits main information and sender information related to an emotion or a state of a sender at the time of the transmission of the main information. The server includes: a receiving unit that receives the main information and the sender information transmitted from the transmission apparatus, and pieces of receiver information related to emotions or states of receivers, the pieces of receiver information being transmitted from the reception apparatuses; and a transmitting unit that transmits the main information, the sender information, and the pieces of receiver information to the respective receivers. Each of the reception apparatuses includes: an acquiring unit that acquires the receiver information; a second communication unit that receives the main information and the sender information transmitted from the server, and transmits the receiver information acquired by the acquiring unit to the server; an analyzing unit that analyzes the main information, the sender information, and the receiver information; and a first determining unit that determines whether the main information is to be presented based on a result of the analysis carried out by the analyzing unit.

The server may further include: a status setting unit that sets emotion statuses of the respective receivers based on the pieces of receiver information; and a second determining unit that determines whether the main information is to be transmitted to the respective receivers based on the emotion statuses set by the status setting unit for the respective receivers. When the determining unit determines that the main information is to be transmitted, the transmitting unit of the server does not transmit the sender information and the pieces of receiver information, and transmits only the main information to the respective receivers. When the determining unit determines that the main information is not to be transmitted, the transmitting unit of the server does not transmit the main information, the sender information, and the pieces of receiver information, and the reception apparatuses do not perform the process with the first determining unit.

An information processing method of the fourth aspect of the present technique is an information processing method compatible with the above described information processing system of the fourth aspect of the present technique.

In the fourth aspect of the present technique, at a transmission apparatus in an information processing system including the transmission apparatus, reception apparatuses, and a server, main information and sender information related to an emotion or a state of a sender at the time of the transmission of the main information are transmitted. At the server, the main information and the sender information transmitted from the transmission apparatus, and pieces of receiver information related to emotions or states of receivers are received, the pieces of receiver information being transmitted from the reception apparatuses; and the main information, the sender information, and the pieces of receiver information are transmitted to the respective receivers. At each of the reception apparatuses, the receiver information is acquired; the main information and the sender information transmitted from the server are received, and the receiver information acquired by the acquiring unit is transmitted to the server; the main information, the sender information, and the receiver information are analyzed; and whether the main information is to be presented is determined based on a result of the analysis.

### Effects of the Invention

As described above, according to the present technique, electronic mail reception can be controlled in accordance with an emotion or a state of the receiver.

### BRIEF DESCRIPTION OF DRAWINGS

FIG. 1 is a block diagram showing an example configuration of an information processing system to which the present technique is applied.

FIG. 2 is a flowchart for explaining the flow of a transmission process.

FIG. 3 is a flowchart for explaining the flow of a reception process.

FIG. 4 is a flowchart for explaining the flow of a sender data analysis process.

FIG. 5 is a diagram for explaining a correspondence table of pictograms and scores.

FIG. 6 is a flowchart for explaining the flow of a determination process.

FIG. 7 is a flowchart for explaining the flow of a feedback process.

FIG. 8 is a block diagram showing an example configuration of an information processing system to which the present technique is applied.

FIG. 9 is a flowchart for explaining the flow of a management process.

FIG. 10 is a flowchart for explaining the flow of a reception process.

FIG. 11 is a block diagram showing an example configuration of an information processing system to which the present technique is applied.

FIG. 12 is a flowchart for explaining the flow of a management process.

FIG. 13 is a flowchart for explaining the flow of a reception process.

FIG. 14 is a block diagram showing an example configuration of an information processing system to which the present technique is applied.

FIG. 15 is a flowchart for explaining the flow of a management process.

FIG. 16 is a flowchart for explaining the flow of a reception process.

FIG. 17 is a block diagram showing an example configuration of the hardware of an information processing apparatus to which the present technique is applied.

### MODES FOR CARRYING OUT THE INVENTION

Three embodiments (hereinafter referred to as the first through third embodiments) will be described later in the following order.

1. First Embodiment (an example of one-to-one communication)

2. Second Embodiment (an example case where determination processes in one-to-N communication are performed at reception terminals)

3. Third Embodiment (an example case where determination processes in one-to-N communication are performed at a server)

### 1. First Embodiment

### Example Configuration of an Information Processing System 1

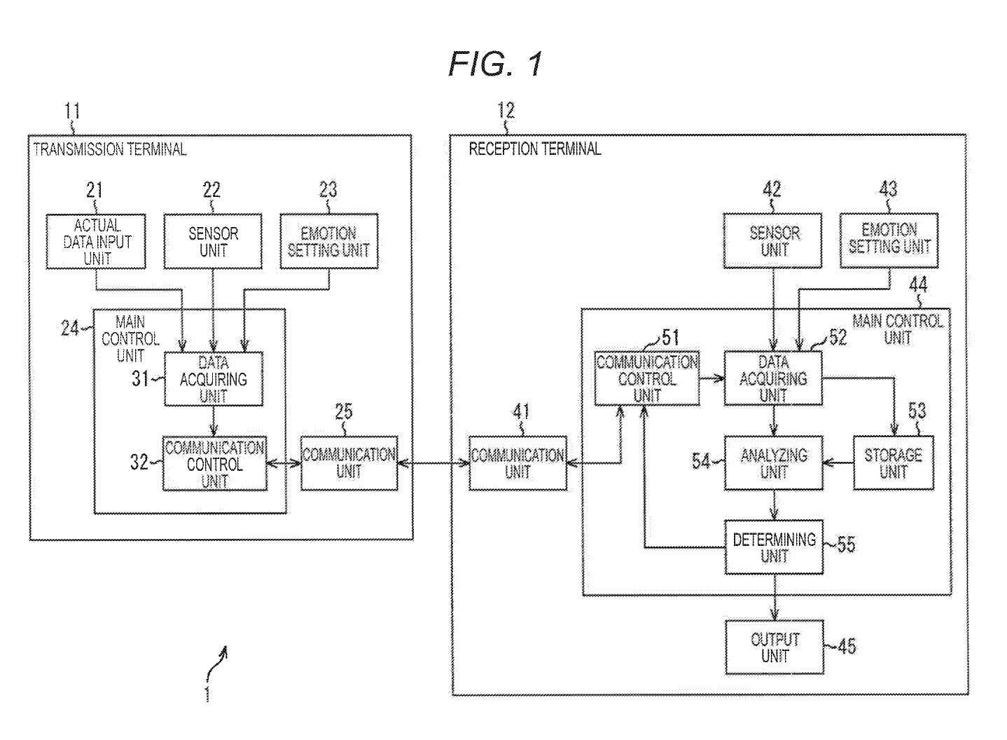

FIG. 1 is a block diagram showing an example configuration of an information processing system 1 to which the present technique is applied.

As shown in FIG. 1, the information processing system 1 is formed with a transmission terminal 11 and a reception terminal 12 that are connected to each other via a network (not shown).

The transmission terminal 11 and the reception terminal 12 are terminals that can be carried around by users, such as portable telephone devices, and are terminals that have a mail function to transmit and receive electronic mail (hereinafter referred to simply as mail), as well as a telephone function.

The transmission terminal 11 transmits data including voice from the telephone function and mail (including text and images) from the mail function, to the reception terminal 12 connected to the network.

The transmission terminal 11 includes an actual data input unit 21, a sensor unit 22, an emotion setting unit 23, a main control unit 24, and a communication unit 25.

The actual data input unit 21 is formed as an input devices such as a microphone, a keyboard, or the like, and inputs data representing voice or mail (hereinafter collectively referred to as actual data) based on an operation of the user of the transmission terminal 11 (the user will be hereinafter referred to as the sender). The keyboard may not be one with physical buttons to be operated, but may be buttons that are displayed on a display and are to be operated.

The sensor unit 22 detects the physical state of the sender, and outputs information indicating the detection result (hereinafter referred to as status information). The sensor unit 22 is formed as a clinical thermometer, a heart rate meter, a pedometer (a registered trade name), an electroencephalograph, a respiration meter, a camera, a microphone, or the like, which is included in or attached to the transmission terminal 11, for example, and detects physical information, an image, sound, or the like, such as a body temperature, a heart rate, a travel distance, brain waves, or a respiration rate. In a case where the sensor unit 22 is an in-camera, for example, the sensor unit 22 images the expression of the sender who is using the transmission terminal 11, and outputs status information that is the image data obtained as a result of the imaging. Other than the above, the sensor unit 22 may be formed as a gyro sensor, a touch panel, or a GPS (Global Positioning System), for example.

The emotion setting unit 23 sets emotion information indicating the emotion status of the sender based on an operation of the sender. For example, if the sender selects his/her own emotion from among the four modes of “delight”, “anger”, “sorrow”, and “pleasure”, the emotion setting unit 23 sets the selected mode as the emotion information.

The main control unit 24 controls the entire operation of the transmission terminal 11. A data acquiring unit 31 and a communication control unit 32 are provided in the main control unit 24.

The data acquiring unit 31 acquires the data of actual data, status information, and emotion information from the actual data input unit 21, the sensor unit 22, and the emotion setting unit 23, respectively. The status information output from the sensor unit 22 and the emotion information set by the emotion setting unit 23 are information indicating the mental state of the sender, and is not necessary information to be processed at the reception terminal 12. That is, the data acquiring unit 31 may acquire only actual data as main information that is input from the actual data input unit 21. Therefore, to be distinguished from necessary actual data, status information and emotion information will be hereinafter referred to as accompanying information as appropriate.

The communication control unit 32 performs control so that the data acquired by the data acquiring unit 31, which is actual data and accompanying information, is transmitted from the communication unit 25 to the reception terminal 12 via the network. Under the control of the communication control unit 32, the communication unit 25 performs communication with the reception terminal 12 via the network.

The reception terminal 12 receives actual data and accompanying information from the transmission terminal 11 having the above structure via the network.

The reception terminal 12 includes a communication unit 41, a sensor unit 42, an emotion setting unit 43, a main control unit 44, and an output unit 45.

Under the control of a communication control unit 51 described later, the communication unit 41 performs communication with the transmission terminal 11 via the network.

The sensor unit 42 detects status information about the physical state of the user. Having substantially the same structure as the sensor unit 22 of the transmission terminal 11, the sensor unit 42 is not described herein.

The emotion setting unit 43 sets emotion information indicating the emotion status of the receiver based on an operation of the user (hereinafter referred to as the receiver) of the reception terminal 12.

The main control unit 44 controls the entire operation of the reception terminal 12. A communication control unit 51, a data acquiring unit 52, a storage unit 53, an analyzing unit 54, and a determining unit 55 are provided in the main control unit 44.

The communication control unit 51 performs control so that the communication unit 41 receives data transmitted from the transmission terminal 11. Hereinafter, data that is transmitted from the transmission terminal 11 and is received by the reception terminal 12 will be referred to as sender data.

The data acquiring unit 52 acquires sender data, status information, and emotion information from the communication control unit 51, the sensor unit 42, and the emotion setting unit 43, respectively.

The storage unit 53 stores the respective kinds of data acquired by the data acquiring unit 52.

The analyzing unit 54 analyzes the sender data in the data acquired by the data acquiring unit 52, to calculate a score representing the emotion status of the sender. The score representing an emotion status of the sender is referred to as a score Ss of the sender.

The analyzing unit 54 also analyzes the status information and the emotion information in the data acquired by the data acquiring unit 52, to calculate a score representing the emotion status of the receiver. The score representing an emotion status of the receiver is referred to as a score Sr of the receiver. Here, in calculating the score Sr of the receiver, at least one of the status information and the emotion information is used.

The determining unit 55 determines whether the sender data can be presented based on results of the analysis carried out by the analyzing unit 54. Specifically, in a case where the score Ss (an analysis result indicating the emotion status of the sender) of the sender and the score Sr (an analysis result indicating the emotion status of the receiver) of the receiver satisfy predetermined conditions, the determining unit 55 determines that the sender data can be presented. If the scores do not satisfy the predetermined conditions, the determining unit 55 determines that the sender data is not to be presented.

In this embodiment, the determining unit 55 compares the score Ss of the sender with the score Sr of the receiver, to compare the emotion status of the sender with the emotion status of the receiver. The determining unit 55 determines whether the sender data can be presented based on the comparison result. That is, when having determined that the emotions of both sides are the same, the determining unit 55 determines that the sender data can be presented. When having determined that the emotions of both sides are not the same, on the other hand, the determining unit 55 determines that the sender data is not to be presented.

If the determination result indicates presentation permission, the determining unit 55 determines a method of presenting the actual data of the sender data. In a case where the actual data as the main information is mail, for example, the method of presenting the actual data can be selected from among the following methods. Specifically, it is possible to employ a method by which the contents of the mail represented by the actual data are displayed on a display that is the output unit 45. Alternatively, it is possible to employ a method by which the actual data is classified in a predetermined folder (such as a “delight” folder) among folders that are set in advance.

If the determination result indicates presentation prohibition, on the other hand, the determining unit 55 determines a method of rejecting the actual data of the sender data. In a case where the actual data is mail, for example, the method of rejecting the actual data can be selected from among the following methods. Specifically, it is possible to employ a method by which the contents of the mail represented by the actual data are displayed on a display that is the output unit 45 a predetermined period of time after the determination. Alternatively, it is possible to employ a method by which the actual data is classified in a predetermined folder (such as a “sorrow” folder) among folders that are set in advance, and is put on hold. Also, it is possible to employ a method by which the actual data is held in the storage unit 53 or the like.

The determining unit 55 further generates feedback information based on the determination result. Ina case where the determination result indicates presentation permission, for example, the determining unit 55 generates a notification to the effect that the actual data has been presented at the reception terminal 12, as feedback information. In a case where the determination result indicates presentation prohibition, on the other hand, the determining unit 55 generates a notification to the effect that the actual data has not been presented at the reception terminal 12, as feedback information. Under the control of the communication control unit 51, the feedback information is transmitted from the communication unit 41 to the transmission terminal 11.

The output unit 45 is formed as a display, a speaker, or the like, and outputs the actual data based on the result of the determination made by the determining unit 55.

Information is transmitted and received between the transmission terminal 11 and the reception terminal 12, as the communication unit 25 is controlled by the communication control unit 32, or the communication unit 41 is controlled by the communication control unit 51. An actual terminal device may have only one of a transmission function and a reception function, but may have both of the functions. A terminal device that has both of the functions have both of the structures of the transmission terminal 11 and the reception terminal 12 shown in FIG. 1.

[Transmission Process]

Next, the series of procedures to be carried out by the transmission terminal 11 to transmit actual data and the like to the reception terminal 12 in the information processing system 1 having the above structure are described (hereinafter referred to as the transmission process).

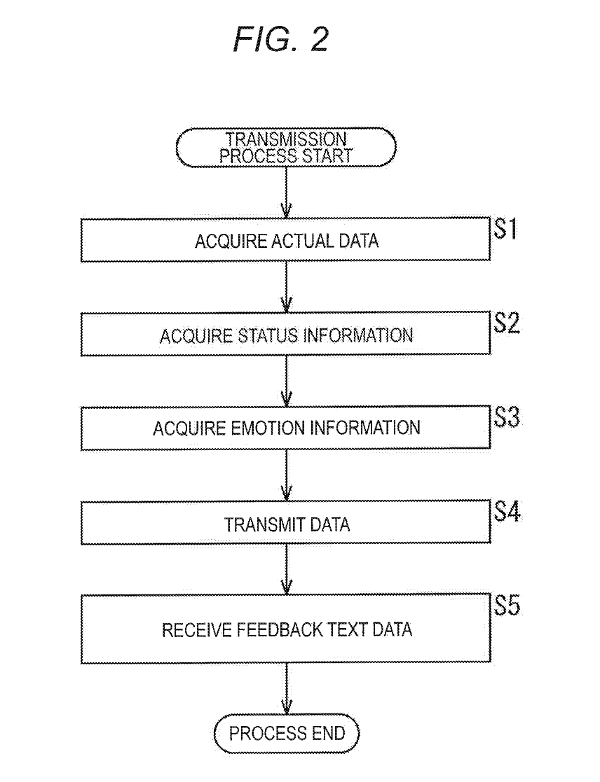

FIG. 2 is a flowchart for explaining the flow of the transmission process.

In step S1, the data acquiring unit 31 acquires actual data that is input from the actual data input unit 21. In the description below, the actual data is mail.

In step S2, the data acquiring unit 31 acquires status information that is output by the sensor unit 22.

In step S3, the data acquiring unit 31 acquires emotion information that is set by the emotion setting unit 23.

In step S4, the communication control unit 32 transmits the data acquired through the respective procedures of steps S1 through S3 to the reception terminal 12. That is, actual data and accompanying information are transmitted to the reception terminal 12.

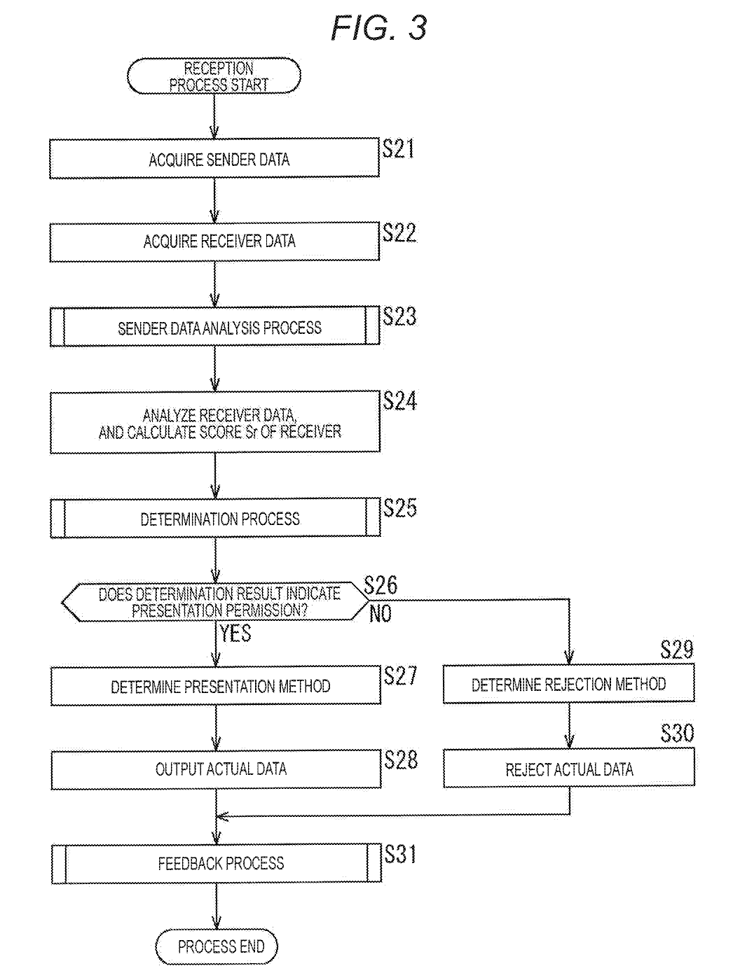

At the reception terminal 12, the actual data and the accompanying information transmitted from the transmission terminal 11 are received as sender data, and a check is made to determine whether the sender data can be presented (step S25 of FIG. 3, which will be described later). Based on results of the determination at the reception terminal 12, feedback information is transmitted to the transmission terminal 11 (step S31 of FIG. 3, which will be described later). In this embodiment, the feedback information from the reception terminal 12 to the transmission terminal 11 is text data, and this text data is referred to as feedback text data.

In step S5, the communication control unit 32 receives the feedback text data transmitted from the reception terminal 12. The received feedback text data is output from an output unit (not shown). As a result, the sender can recognize whether the actual data has been presented at the reception terminal 12.

At this point, the transmission process comes to an end.

[Reception Process]

Next, the series of procedures to be carried out by the reception terminal 12 from the reception of the sender data from the transmission terminal 11 to the transmission of the feedback text data to the transmission terminal 11 are described (hereinafter referred to as the reception process).

FIG. 3 is a flowchart for explaining the flow of the reception process.

When the communication control unit 51 controls the communication unit 41 and receives data transmitted from the transmission terminal 11, or data containing actual data and accompanying information as sender data, a reception process is started, and the procedures of step S21 and the later steps described below are carried out.

In step S21, the data acquiring unit 52 acquires sender data.

In step S22, the data acquiring unit 52 acquires receiver data. Specifically, the data acquiring unit 52 acquires the status information about the receiver that is output from the sensor unit 42, and the emotion information about the receiver that is set by the emotion setting unit 43.

In step S23, the analyzing unit 54 performs a sender data analysis process that is a process of analyzing the sender data acquired through the procedure of step S21.

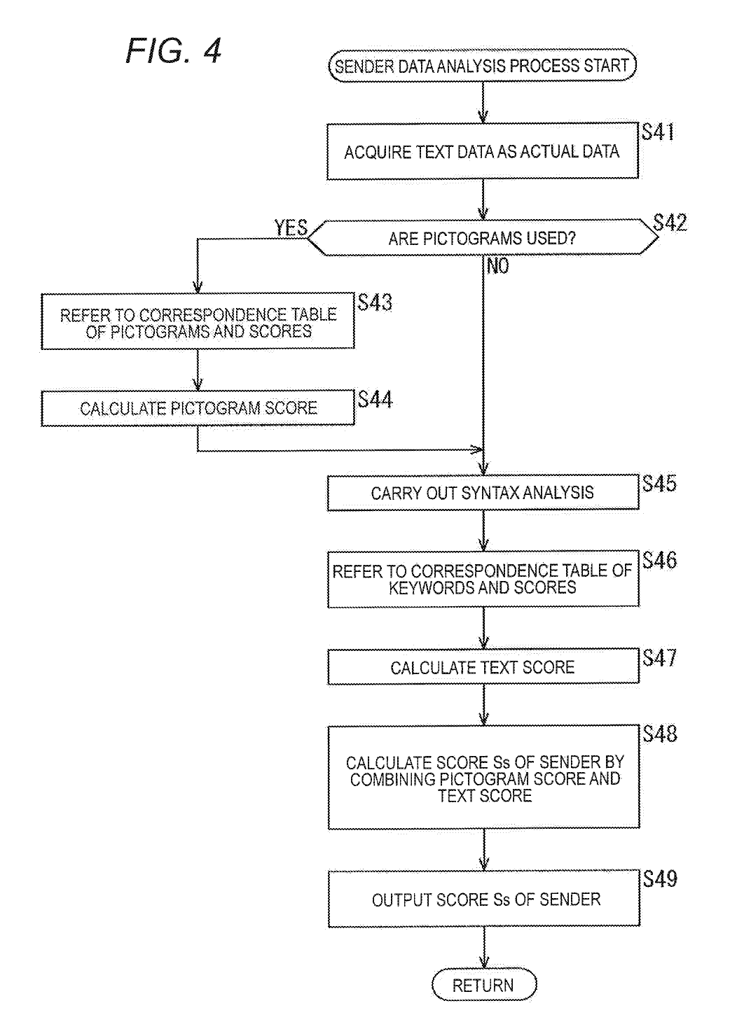

Referring now to FIG. 4, the sender data analysis process is described in detail. For ease of explanation, FIG. 4 shows a process of analyzing the actual data in the sender data.

[Sender Data Analysis Process]

FIG. 4 is a flowchart for explaining the flow of the sender data analysis process.

In step S41, the analyzing unit 54 acquires text data as the actual data contained in the sender data acquired through the procedure of step S21. Specifically, the contents of mail are acquired.

In step S42, the analyzing unit 54 determines whether pictograms are used in the text data.

In a case where no pictograms are used in the text data, the result of the determination in step S42 is “NO”, and the process moves on to step S45. The procedures of step S45 and the later steps will be described later.

In a case where pictograms are used in the text data, on the other hand, the result of the determination in step S42 is “YES”, and the process moves on to step S43.

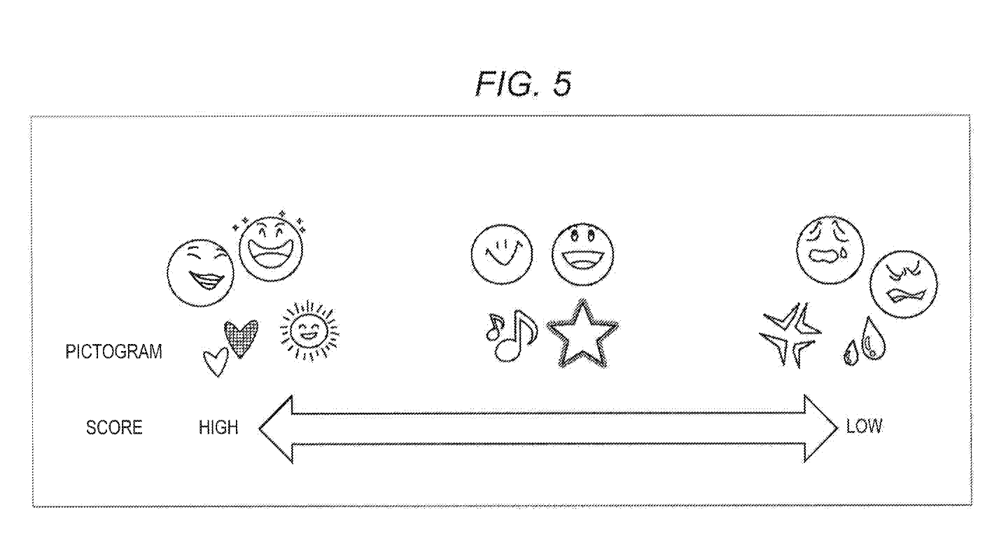

In step S43, the analyzing unit 54 refers to a correspondence table of pictograms and scores. The reception terminal 12 stores the correspondence table of pictograms and scores in advance. Referring now to FIG. 5, the correspondence table of pictograms and scores is described.

FIG. 5 is a diagram for explaining the correspondence table of pictograms and scores.

As shown in FIG. 5, high scores are associated with positive pictograms expressing smiling faces or hearts (the pictograms shown on the left side in FIG. 5). Meanwhile, low scores are associated with negative pictograms expressing crying or angry faces (the pictograms shown on the right side in FIG. 5). Intermediate scores are associated with intermediate-level pictograms expressing normal faces (the pictograms shown at the center in FIG. 5).

Referring back to FIG. 4, in step S44, the analyzing unit 54 calculates a pictogram score. For example, the analyzing unit 54 calculates a pictogram score by combining all the scores associated with the pictograms included in the text data. The process then moves on to step S45.

In step S45, the analyzing unit 54 carries out syntax analysis on the text data. Specifically, the analyzing unit 54 extracts a keyword related to the emotion of the receiver by carrying out syntax analysis on the text data.

In step S46, the analyzing unit 54 refers to a correspondence table of keywords and scores. The reception terminal 12 stores the correspondence table of keywords and scores in advance. In the correspondence table of keywords and scores, high scores are associated with keywords expressing positive emotions, while low scores are associated with keywords expressing negative emotions. Intermediate scores are associated with keywords expressing intermediate emotions between both the emotions.

In step S47, the analyzing unit 54 calculates a text score. For example, the analyzing unit 54 calculates a text score by combining all the scores associated with the keywords included in the text data.

In step S48, the analyzing unit 54 calculates a score Ss of the sender by combining the pictogram score and the text score.

In step S49, the analyzing unit 54 outputs the score Ss of the sender.

At this point, the sender data analysis process comes to an end, and the process moves on to step S24 of FIG. 3.

When calculating the score Ss of the sender, the analyzing unit 54 may further add a result of analysis of the accompanying information received from the transmission terminal 11 to the score Ss.

In a case where the status information in the accompanying information is information indicating a heart rate detected by the heart rate meter of the sensor unit 22, for example, the analyzing unit 54 calculates a score by referring to a correspondence table of heart rates and scores. For example, in the correspondence table of heart rates of the sender at times of data transmission and scores, high scores representing positive states are associated with higher heart rates than the average value of heart rates of the sender at ordinary times, and low scores representing negative states are associated with lower heart rates than the average value. Intermediate scores are associated with intermediate heart rates.

In a case where the status information in the accompanying information is information indicating the voice detected by the microphone of the sensor unit 22, for example, the analyzing unit 54 calculates a score by referring to a correspondence table of voices and scores. For example, in the correspondence table of pitches of voices of the sender at times of data transmission and scores, higher scores representing positive states in accordance with differences are associated with voices at higher pitches than the average value of the pitches of voices during a certain period from a time of data transmission to a predetermined time earlier. Meanwhile, lower scores in accordance with differences are associated with voices at lower pitches than the average value. Intermediate scores are associated with voices close to the average value.

In a case where the emotion information in the accompanying information is set in one of the four modes of “delight”, “anger”, “sorrow”, and “pleasure”, for example, the analyzing unit 54 calculates a score by referring to a correspondence table of the modes and scores. For example, high scores representing positive states are associated with the “delight” and “pleasure” modes, and low scores representing negative states are associated with the “anger” and “sorrow” modes.

When calculating the score Ss of the sender, the analyzing unit 54 may further add results of analysis carried out on the usage history, the user setting mode, and the like of the transmission terminal 11, as well as the accompanying information, to the score Ss.

In step S24, the analyzing unit 54 calculates a score Sr of the receiver by analyzing the receiver data acquired by the data acquiring unit 52 through the procedure of step S22. Specifically, the analyzing unit 54 calculates the score Sr of the receiver by analyzing the status information acquired by the sensor unit 42, and the emotion information acquired by the emotion setting unit 43. The analysis method here is the same as the sender data analysis method, and therefore, explanation thereof is skipped.

In step S25, the determining unit 55 performs a process (hereinafter referred to as the determination process) of determining whether the sender data can be presented based on the result of the analysis in step S24.

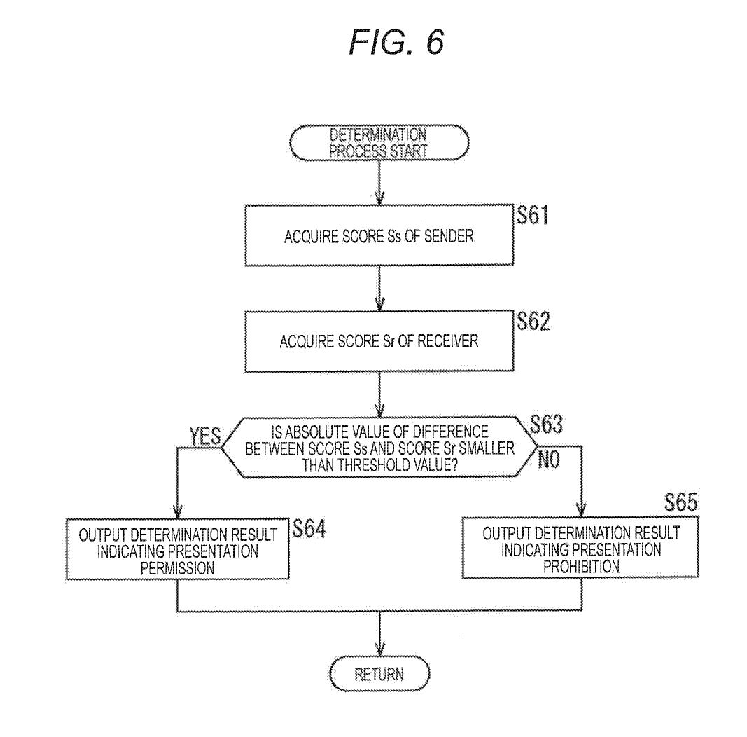

Referring now to FIG. 6, the determination process is described in detail.

[Determination Process]

FIG. 6 is a flowchart for explaining the flow of the determination process.

In step S61, the determining unit 55 acquires the score Ss of the sender calculated through the procedure of step S23.

In step S62, the determining unit 55 acquires the score Sr of the receiver calculated through the procedure of step S24.

In step S63, the determining unit 55 determines whether the absolute difference between the score Ss and the score Sr is smaller than a threshold value.

If the absolute difference between the score Ss and the score Sr is smaller than the threshold value, the result of the determination in step S63 is “YES”, and the process moves on to step S64. That is, in this case, the emotion of the sender and the emotion of the receiver are determined to be the same.

In step S64, the determining unit 55 outputs a determination result indicating presentation permission. At this point, the determination process comes to an end, and the process moves on to step S26 of FIG. 3.

If the absolute difference between the score Ss and the score Sr is not smaller than the threshold value, on the other hand, the result of the determination in step S63 is “NO”, and the process moves on to step S65. That is, in this case, the emotion of the sender and the emotion of the receiver are determined not to be the same.

In step S65, the determining unit 55 outputs a determination result indicating presentation prohibition. At this point, the determination process comes to an end, and the process moves on to step S26 of FIG. 3.

In step S26, the determining unit 55 determines whether the determination result indicates presentation permission.

If the determination result indicates presentation permission, the result of the determination in step S26 is “YES”, and the process moves on to step S27.

In step S27, the determining unit 55 determines a presentation method. Specifically, the determining unit 55 selects one method from among various kinds of methods, such as a method by which the contents of the mail represented by the actual data are immediately displayed by the output unit 45, and a method by which the mail is classified in a predetermined folder (such as a “delight” folder) among folders that are set in advance, as described above.

In step S28, the output unit 45 outputs the actual data (or the mail). That is, the output unit 45 presents the contents of the mail in accordance with the presentation method determined by the determining unit 55 through the procedure of step S27.

The process then moves on to step S31. The procedures of step S31 and the later steps will be described later.

If the determination result indicates presentation prohibition, on the other hand, the result of the determination in step S26 is “NO”, and the process moves on to step S29.

In step S29, the determining unit 55 determines a rejection method. Specifically, the determining unit 55 selects one method from among various kinds of methods, such as a method by which the contents of the mail are displayed by the output unit 45 a predetermined period of time after the determination, and a method by which the mail is classified in a predetermined folder (such as a “sorrow” folder) among folders that are set in advance, as described above.

In step S30, the output unit 45 rejects the actual data (or the mail). That is, the output unit 45 rejects the mail in accordance with the rejection method determined by the determining unit 55 through the procedure of step S30.

The process then moves on to step S31, and the determining unit 55 performs a feedback process.

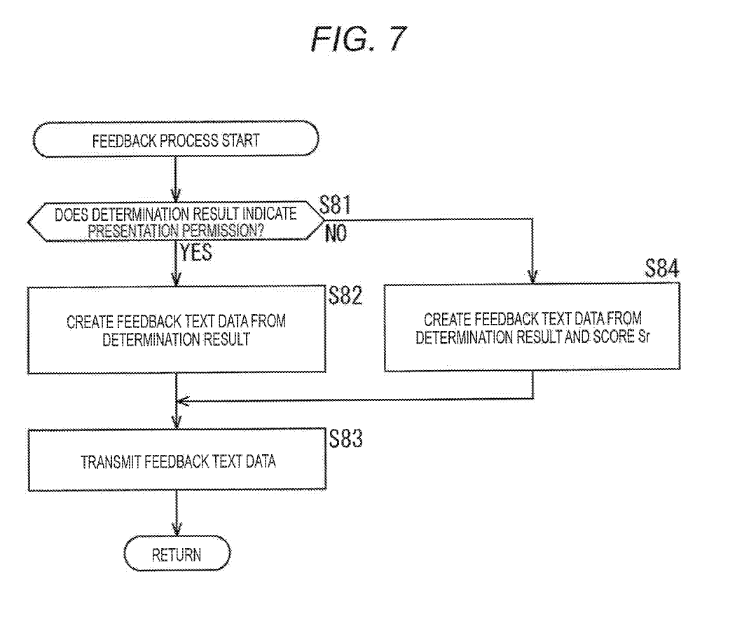

Referring now to FIG. 7, the feedback process is described.

[Feedback Process]

FIG. 7 is a flowchart for explaining the flow of the feedback process.

In step S81, the determining unit 55 determines whether the determination result output through the procedure of step S25 indicates presentation permission.

If the determination result indicates presentation permission, the result of the determination in step S81 is “YES”, and the process moves on to step S82.

In step S82, the determining unit 55 creates feedback text data from the determination result. Specifically, the determining unit 55 creates feedback text data to the effect that the contents of the mail represented by the actual data have been presented at the reception terminal 12. As a result, a feedback text, “Mail has been successfully transmitted.”, is created, for example.

In step S83, the determining unit 55 transmits the created feedback text data to the transmission terminal 11 via the communication control unit 51.

If the determination result does not indicate presentation permission or indicates presentation prohibition, on the other hand, the result of the determination in step S81 is “NO”, and the process moves on to step S84.

In step S84, the determining unit 55 creates feedback text data from the determination result and the score Sr of the receiver. Specifically, the determining unit 55 creates feedback text data to the effect that the contents of the mail represented by the actual data have been rejected at the reception terminal 12. If the score Sr of the receiver is a score indicating a state where the receiver is angry, for example, feedback text data, “Transmission of mail has failed; the other end now seems to be angry.”, is created.

The process then moves on to step S83, and the created feedback text data is transmitted to the transmission terminal 11.

At this point, the feedback process in step S31 comes to an end, and the reception process shown in FIG. 3 also comes to an end.

As described above, in the information processing system 1, the timing to present actual data can be controlled in accordance with the emotion or the state of the receiver. Accordingly, stress on the receiver can be reduced, and delight of the receiver can be increased.

Furthermore, as feedback information is transmitted from the reception terminal 12 to the transmission terminal 11, the sender can recognize whether the actual data has been presented at the reception terminal 12.

Although the feedback information transmitted from the reception terminal 12 to the transmission terminal 11 in the above described example is text data, the feedback information is not limited to that. The feedback information may be in the form of an image, vibration, or sound, for example. The contents of the feedback information is not limited to a text formed by adding information about the emotion or the state of the other end to binary information indicating success or failure as described above. If the determination result indicates presentation prohibition, for example, an idea for an improvement of the contents of the actual data transmitted by the sender may be transmitted as the feedback information to the transmission terminal 11.

In the determination process in the above described example, a determination result is determined by comparing the absolute difference between a score Ss of the sender and a score Sr of the receiver with a threshold value. However, the method of performing the determination process is not limited to this, and a table for determining a determination result in accordance with a combination of a score Ss of the sender and a score Sr of the receiver may be used.

### 2. Second Embodiment

In the information processing system 1 of the first embodiment, one-to-one communication is performed, as actual data is transmitted from the transmission terminal 11 to the single reception terminal 12. However, communication between a transmission terminal and a reception terminal is not limited to this method. In view of this, the second embodiment described below is an embodiment of an information processing system in which one-to-N(N being an integer of 2 or greater) communication is performed, as actual data is transmitted from a transmission terminal to reception terminals.

[Example Configuration of an Information Processing System 101]

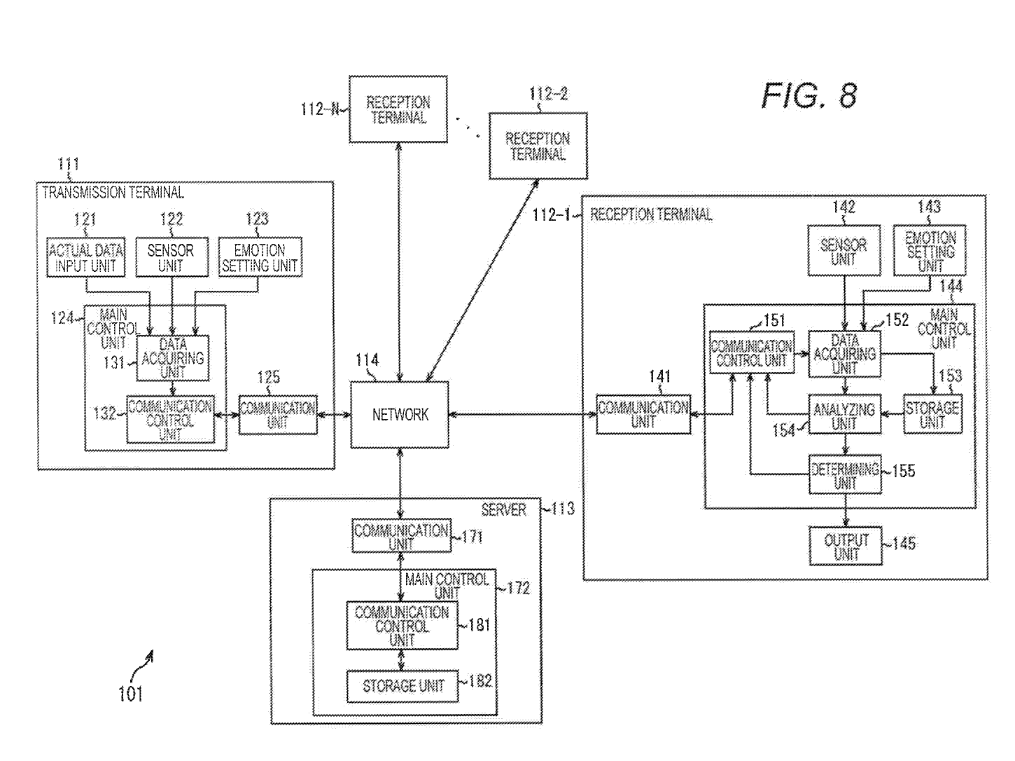

FIG. 8 is a block diagram showing an example configuration of an information processing system 101 to which the present technique is applied.

As shown in FIG. 8, the information processing system 101 is formed with a transmission terminal 111, reception terminals 112-1 through 112-N, and a server 113 that are connected to one another via a network 114. In the description below, the reception terminals 112-1 through 112-N will be collectively referred to as the reception terminal 112, unless required to be distinguished from one another.

The structures and the processes in the transmission terminal 111 and the reception terminal 112 shown in FIG. 8 are basically the same as the structures in the transmission terminal 11 and the reception terminal 12 shown in FIG. 1. Therefore, in the following description of the transmission terminal 111 and the reception terminal 112, the same aspects as those of the transmission terminal 11 and the reception terminal 12 shown in FIG. 1 will not be described, and only different aspects will be described.

The transmission terminal 111 transmits data including voice from the telephone function and mail (including text and images) from the mail function, to the server 113 connected to the network 114.

The transmission terminal 111 includes an actual data input unit 121, a sensor unit 122, an emotion setting unit 123, a main control unit 124, and a communication unit 125. A data acquiring unit 131 and a communication control unit 132 are provided in the main control unit 124.

The communication control unit 132 performs control so that the data acquired by the data acquiring unit 131, which is actual data and accompanying information, is transmitted from the communication unit 125 to the server 113 via the network 114.

The server 113 manages respective kinds of data to be transmitted and received between the transmission terminal 111 and the reception terminal 112 via the network 114. The server 113 is designed to include a communication unit 171 and a main control unit 172.

Under the control of a communication control unit 181 described later, the communication unit 171 performs communication with the transmission terminal 111 or the reception terminal 112 via the network 114.

The main control unit 172 controls the entire operation of the server 113. The communication control unit 181 and a storage unit 182 are provided in the main control unit 172.

The communication control unit 181 performs control so that the communication unit 171 receives actual data and accompanying information transmitted from the transmission terminal 111. The communication control unit 181 also performs control so that the communication unit 171 receives a score Sr of the receiver that is regularly uploaded from each of the N reception terminals 112.

The storage unit 182 stores the actual data and the accompanying information received by the communication control unit 181. The storage unit 182 also stores the scores Sr that are of the respective receivers using the N reception terminals 112, and are regularly received by the communication control unit 181.

The communication control unit 181 performs control so that the actual data and the accompanying information received from the transmission terminal 111 are transmitted from the communication unit 171 to each of the N reception terminals 112. At this point, the communication control unit 181 performs control so that the scores Sr of the respective receivers using the other (N−1) reception terminals 112-j (j=1, 2, . . . , N, but j≠i), which are stored in the storage unit 182, are transmitted together with the actual data and the accompanying information from the communication unit 171 to each of the N reception terminals 112-i (i=1, 2, . . . , N).

The reception terminal 112 receives the actual data and the accompanying information, which have been transmitted from the transmission terminal 111, from the server 113 via the network 114. The scores Sr of the receivers using the other (N−1) reception terminals 112 are also received from the server 113.

The reception terminal 112 is designed to include a communication unit 141, a sensor unit 142, an emotion setting unit 143, a main control unit 144, and an output unit 145. A communication control unit 151, a data acquiring unit 152, a storage unit 153, an analyzing unit 154, and a determining unit 155 are provided in the main control unit 144.

The communication control unit 151 performs control so that the communication unit 141 receives data transmitted from the server 113. Specifically, the communication control unit 151 performs control so that the communication unit 141 receives the actual data and the accompanying information (hereinafter referred to as the sender data) transmitted from the transmission terminal 111 via the server 113, and the scores Sr of the respective receivers using the other reception terminals 112, which have been transmitted from the server 113.

The data acquiring unit 152 acquires the sender data, the scores Sr of the respective receivers using the other reception terminals 112, status information, and emotion information from the communication control unit 151, the sensor unit 142, and the emotion setting unit 143, respectively.

The analyzing unit 154 analyzes the sender data in the data acquired by the data acquiring unit 152, to calculate the score Ss of the sender.

The analyzing unit 154 also analyzes the status information and the emotion information in the data acquired by the data acquiring unit 152, to calculate the score Sr of the receiver. Under the control of the communication control unit 151, the analyzing unit 154 uploads the calculated score Sr of the receiver from the communication unit 141 to the server 113. The analyzing unit 154 regularly calculates the score Sr of the receiver, and uploads the score Sr to the server 113. At the other reception terminals 112, the scores Sr of the receivers are also regularly calculated and uploaded to the server 113.

In the information processing system 101 shown in FIG. 8, the transmission terminal 111 also functions as a reception terminal 112 if some other apparatus is functioning as a transmission terminal. In such a case, the score Sr of the receiver is regularly calculated and uploaded to the server 113. However, cases where the transmission terminal 111 functions as a reception terminal 112 are not described herein, for ease of explanation.

The determining unit 155 determines whether the sender data can be presented based on the results of the analysis carried out by the analyzing unit 154, and the scores Sr of the respective receivers using the other reception terminals 112, which have been acquired by the data acquiring unit 152.

Specifically, in a case where the score Ss (an analysis result indicating the emotion status of the sender) of the sender, the score Sr (an analysis result indicating the emotion status of the receiver) of the receiver, and the scores Sr (analysis results indicating the emotion statuses of the other receivers) of the respective receivers using the other reception terminals 112 satisfy predetermined conditions, the determining unit 155 determines that the sender data can be presented. If the scores do not satisfy the predetermined conditions, the determining unit 155 determines that the sender data are not to be presented.

In this embodiment, the determining unit 155 compares the score Ss of the sender, the score Sr of the receiver, and the scores Sr of the respective receivers using the other reception terminals 112, to compare the emotion status of the sender with the emotion statuses of all the receivers. The determining unit 155 then determines whether the sender data can be presented based on the comparison result. That is, when having determined that the emotions of both sides are the same, the determining unit 155 determines that the sender data can be presented. When having determined that the emotions of both sides are not the same, on the other hand, the determining unit 155 determines that the sender data is not to be presented.

If the determination result indicates presentation permission, the determining unit 155 determines a method of presenting the actual data of the sender data. If the determination result indicates presentation prohibition, on the other hand, the determining unit 155 determines a method of rejecting the actual data of the sender data. Since the actual data presentation method and the actual data rejection method have been described above, explanation thereof is not repeated herein.

The determining unit 155 further generates feedback information based on the determination result. Under the control of the communication control unit 151, the feedback information is transmitted from the communication unit 141 to the transmission terminal 111 via the server 113.

The server 113 transmits the feedback information received from the reception terminal 112, to the transmission terminal 111. In a case where the feedback information is not transmitted from the reception terminal 112 even after a predetermined period of time has passed, the server 113 may transmit a notification to the effect that the actual data has not been presented at the reception terminal 112, as the feedback information to the transmission terminal 111.

Information is transmitted and received among the transmission terminal 111, the reception terminal 112, and the server 113, as the communication unit 125 is controlled by the communication control unit 132, the communication unit 141 is controlled by the communication control unit 151, or the communication unit 171 is controlled by the communication control unit 181.

[Transmission Process]

Next, a transmission process to be performed by the transmission terminal 111 in the information processing system 101 having the above structure, or the series of procedures to be carried out by the transmission terminal 111 to transmit actual data and the like to the server 113, is described (hereinafter referred to as the transmission process).

The flow of the transmission process to be performed by the transmission terminal 111 is basically the same as the flow of the transmission process performed by the transmission terminal 11 in FIG. 2. Therefore, explanation thereof is skipped herein. However, in the transmission process to be performed by the transmission terminal 111, the respective pieces of data acquired by the data acquiring unit 131, which are actual data and accompanying information, are transmitted to the server 113.

A check is made to determine whether the actual data can be presented at the reception terminal 112, and feedback text data generated based on the result of the determination is transmitted to the transmission terminal ill via the server 113. That is, the communication control unit 132 receives feedback text data transmitted from the server 113.

[Management Process]

Next, the series of procedures to be carried out by the server 113 from the transmission of actual data and accompanying information received from the transmission terminal 111 to the reception terminal 112, to the transmission of feedback text data received from the reception terminal 112 to the transmission terminal 111 are described (hereinafter referred to as the management process).

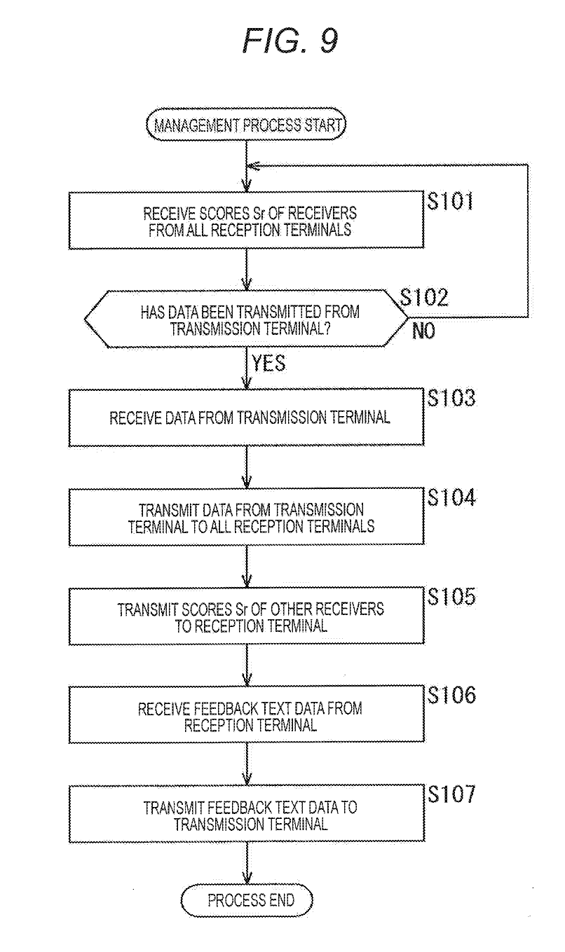

FIG. 9 is a flowchart for explaining the flow of the management process.

In step S101, the communication control unit 181 receives the scores Sr of the receivers from all the reception terminals 112. The storage unit 182 stores the received scores Sr of the receivers. The scores Sr of the receivers are transmitted on a regular basis.

In step S102, the communication control unit 181 determines whether data has been transmitted from the transmission terminal 111. Specifically, the communication control unit 181 determines whether actual data and accompanying information have been transmitted from the transmission terminal 111.

If data has not been transmitted from the transmission terminal 111, the result of the determination in step S102 is “NO”, and the process returns to step S101, so that the procedures thereafter are repeated. That is, the loop process of steps S101 and S102 is repeated until data is transmitted from the transmission terminal 111.

When data is transmitted from the transmission terminal 111 after that, the result of the determination in step S102 is “YES”, and the process moves on to step S103.

In step S103, the communication control unit 181 receives the data from the transmission terminal 111.

In step S104, the communication control unit 181 transmits the data from the transmission terminal 111 to all the reception terminals 112. That is, the actual data and the accompanying information are transmitted to all the reception terminals 112.

In step S105, the communication control unit 181 transmits the scores Sr of the receivers using the other reception terminals 112 to the reception terminal 112. The procedures of steps S104 and S105 are carried out substantially at the same time.

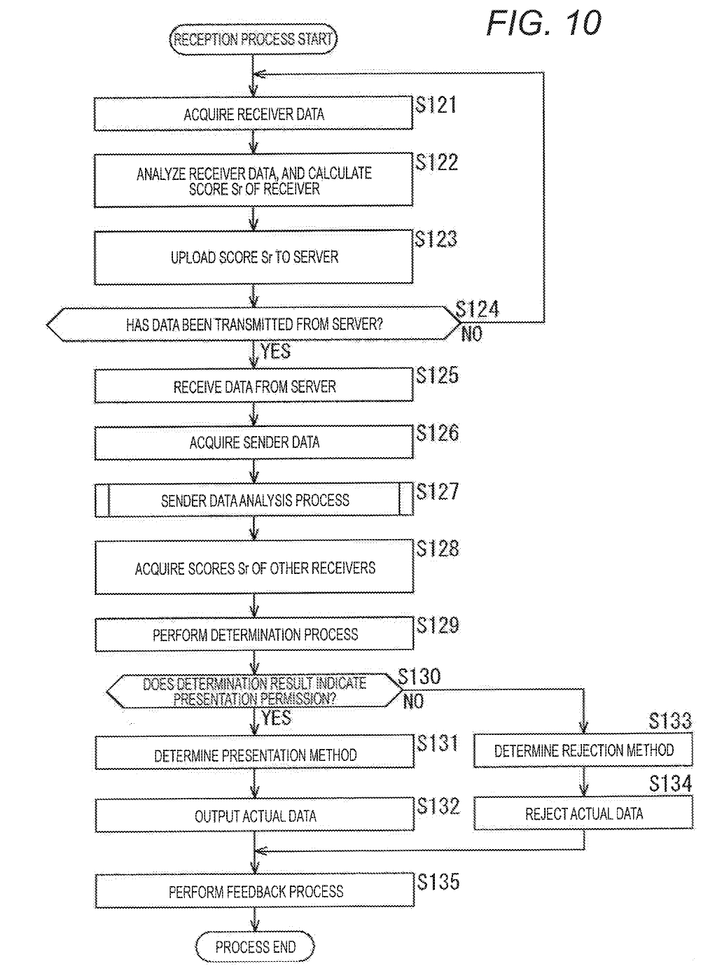

At the reception terminal 112, the actual data and the accompanying information transmitted from the server 113 are received as sender data, and the scores Sr of the other receivers are also received (step S125 of FIG. 10, which will be described later). A check is then made to determine whether the sender data can be presented based on those pieces of information. Feedback text data is then transmitted to the server 113 based on the result of the determination at the reception terminal 112.

In step S106, the communication control unit 181 receives the feedback text data transmitted from the reception terminal 112.

In step S107, the communication control unit 181 transmits the feedback text data received through the procedure of step S106 to the transmission terminal 111.

At this point, the management process comes to an end.

[Reception Process]

Next, the series of procedures to be carried out by the reception terminal 112 from the reception of the sender data and the scores Sr of the other receivers from the server 113 to the transmission of the feedback text data to the server 113 are described (hereinafter referred to as the reception process).

FIG. 10 is a flowchart for explaining the flow of the reception process.

In step S121, the data acquiring unit 152 acquires receiver data. Specifically, the data acquiring unit 152 acquires the status information about the receiver that is output from the sensor unit 142, and the emotion information about the receiver that is set by the emotion setting unit 143.

In step S122, the analyzing unit 154 calculates a score Sr of the receiver by analyzing the receiver data acquired by the data acquiring unit 152 through the procedure of step S121. Here, the analysis method may be exactly the same as the method described in the first embodiment.

In step S123, the communication control unit 151 uploads the score Sr of the receiver calculated through the procedure of step S122 to the server 113.

In step S124, the communication control unit 151 determines whether data has been transmitted from the server 113. Specifically, the communication control unit 151 determines whether actual data, accompanying information, and the scores Sr of the other receivers have been transmitted from the transmission terminal 111 via the server 113.

If data has not been transmitted from the server 113, the result of the determination in step S124 is “NO”, and the process returns to step S121, so that the procedures thereafter are repeated. That is, the procedures of steps S121 through S124 are repeated until, data is transmitted from the server 113.

When data is transmitted from the server 113 after that, the result of the determination in step S124 is “YES”, and the process moves on to step S125.

In step S125, the communication control unit 151 receives the data from the server 113. Specifically, the data containing the actual data and the accompanying information is received as the sender data, and the scores Sr of the other receivers are also received.

In step S126, the data acquiring unit 152 acquires the sender data received through the procedure of step S125.

In step S127, the analyzing unit 154 performs the sender data analysis process described above with reference to FIG. 4, to analyze the sender data acquired through the procedure of step S126. As a result, the score Ss of the sender is calculated.

In step S128, the data acquiring unit 152 acquires the scores Sr of the other receivers received through the procedure of step S125.

In step S129, the determining unit 155 performs a determination process. For example, the determining unit 155 compares the score Sr of the receiver calculated through the procedure of step S122, the score Ss of the sender calculated through the procedure of step S127, and the scores Sr of the other receivers acquired through the procedure of step S128, to compare the emotion status of the sender with the emotion statuses of all the receivers. That is, when having determined that the emotions of both sides are the same, the determining unit 155 determines that the sender data can be presented. When having determined that the emotions of both sides are not the same, on the other hand, the determining unit 155 determines that the sender data is not to be presented. In a case where all the scores are scores representing positive states, for example, the determining unit 155 outputs a determination result indicating presentation permission. In any other cases, the determining unit 155 outputs a determination result indicating presentation prohibition.

In step S130, the determining unit 155 determines whether the determination result indicates presentation permission.

If the determination result indicates presentation permission, the result of the determination in step S130 is “YES”, and the process moves on to step S131.

In step S131, the determining unit 155 determines a presentation method. Specifically, the determining unit 155 selects a presentation method from among the above described methods.

In step S132, the output unit 145 outputs the actual data (or mail). That is, the output unit 145 presents the contents of the mail in accordance with the presentation method determined by the determining unit 155 through the procedure of step S131.

The process then moves on to step 3135. The procedures of step S135 and the later steps will be described later.

If the determination result indicates presentation prohibition, on the other hand, the result of the determination in step S130 is “NO”, and the process moves on to step S133.

In step S133, the determining unit 155 determines a rejection method. Specifically, the determining unit 155 selects a presentation method from among the above described methods.

In step S134, the output unit 145 rejects the actual data (or the mail). That is, the output unit 145 rejects the mail in accordance with the rejection method determined by the determining unit 155 through the procedure of step S134.

The process then moves on to step S135, and the determining unit 155 performs a feedback process. As a result, feedback information is transmitted to the server 113. The feedback process is basically the same as the flow of the feedback process shown in FIG. 7. In the feedback process to be performed by the determining unit 155, however, feedback text data created based on the determination result is transmitted to the server 113.

As described above, the server 113 transmits the received feedback text data to the transmission terminal 111. At this point, the reception process comes to an end.

As described above, in the information processing system 101 in which actual data is transmitted from the transmission terminal 111 to the reception terminals 112, the timing to present the actual data can also be controlled in accordance with the emotion or the state of the receiver. Accordingly, stress on the receiver can be reduced, and delight of the receiver can be increased.

Furthermore, as feedback information is transmitted from the reception terminal 112 to the transmission terminal 111 via the server 113, the sender can recognize whether the actual data has been presented at the reception terminal 112.

### 3. Third Embodiment

In the information processing system 101 of the second embodiment, the determination process to determine whether actual data can be presented is performed at the reception terminal 112. However, the site where the determination process is performed is not particularly limited. In view of this, an embodiment of an information processing system in which a server performs the determination process will be described below as a third embodiment.

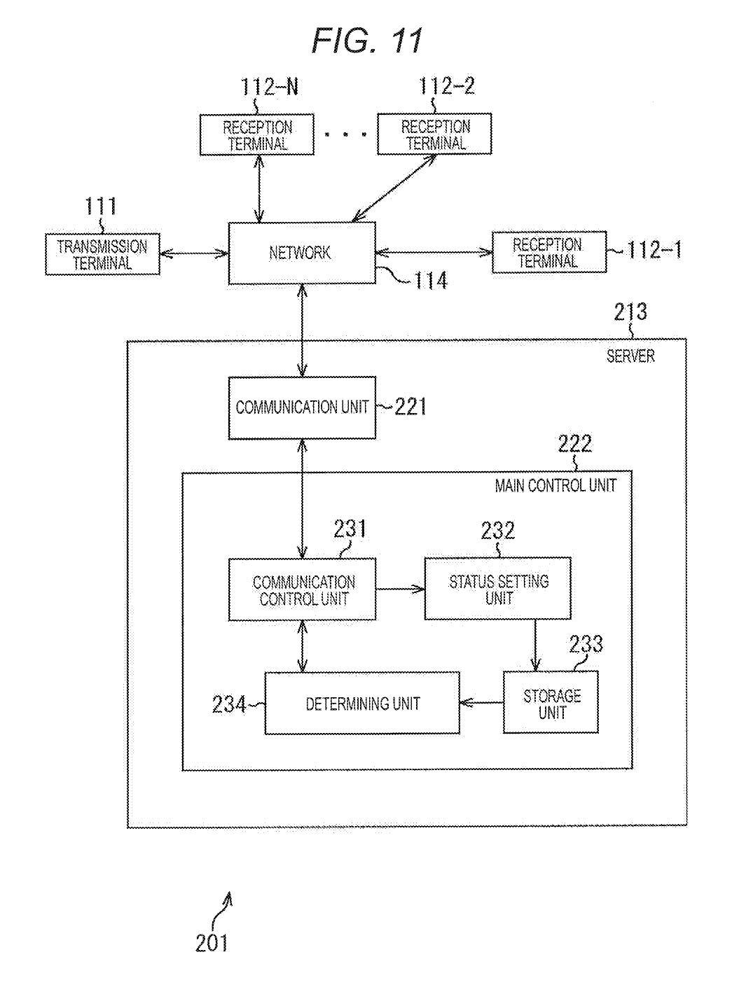

FIG. 11 is a block diagram showing an example configuration of an information processing system 201 to which the present technique is applied.

As shown in FIG. 11, the information processing system 201 is formed with a transmission terminal 111, reception terminals 112-1 through 112-N (N being an integer of 1 or greater), and a server 213 that are connected to one another via a network 114. In the information processing system 201 shown in FIG. 11, the structures and processes in the transmission terminal 111, the reception terminals 112-1 through 112-N, and the network 114 are basically the same as chose in the transmission terminal 111, the reception terminal 112, and the network 114 of the information processing system 101 shown in FIG. 8. However, as the determination process is to be performed at the server 213 in this embodiment, the determining unit 155 shown in FIG. 8 does not function in the reception terminal 112. Therefore, in the description of the information processing system 201 of the third embodiment below, the different aspects from the information processing system 101 of the second embodiment, or the server 213, will be mainly explained.

The server 213 manages respective kinds of data to be transmitted and received between the transmission terminal 111 and the reception terminals 112 via the network 114. The server 213 is designed to include a communication unit 221 and a main control unit 222.

Under the control of a communication control unit 231 described later, the communication unit 221 performs communication with the transmission terminal 111 and the reception terminal 112 via the network 114.

The main control unit 222 controls the entire operation of the server 213. A communication control unit 231, a status setting unit 232, a storage unit 233, and a determining unit 234 are provided in the main control unit 222.

The communication control unit 231 performs control so that the communication unit 221 receives actual data and accompanying information transmitted from the transmission terminal 111. The communication control unit 231 also performs control so that the communication unit 221 receives a score Sr of the receiver that is regularly uploaded from each of the N reception terminals 112.

The status setting unit 232 sets an emotion status in accordance with each of the scores Sr of the respective receivers using the N reception terminals 112, which have been received under the control of the communication control unit 231. Specifically, the status setting unit 232 sets binary information indicating a positive state or a negative state as the emotion of the receiver based on the score Sr of the receiver. The types of the number of emotion statuses are not limited to the above.

The storage unit 233 stores the scores Sr of the respective receivers using the N reception terminals 112, which have been set by the status setting unit 232.

The determining unit 234 determines whether actual data received from the transmission terminal 111 can be transmitted to the reception terminal 112 based on the emotion statuses of the respective receivers using the N reception terminals 112, which have been set by the status setting unit 232. Specifically, in a case where the emotion statuses of the receivers using the N reception terminals 112 satisfy predetermined conditions, the determining unit 234 determines that the actual data can be transmitted to the N reception terminals 112. In a case where the emotion statuses do not satisfy the predetermined conditions, the determining unit 234 determines that the actual data is not to be transmitted.

In this embodiment, the determining unit 234 determines whether the actual data can be transmitted based on the result of comparison among the emotion statuses of the respective receivers using the N reception terminals 112. Specifically, when having determined that the emotion statuses of all the receivers are the same (or where the emotion statuses of all the receivers indicate positive states), the determining unit 234 determines that the actual data can be transmitted. When having determined that the emotion statuses of all the receivers are not the same, on the other hand, the determining unit 234 determines' that the actual data is not to be transmitted.

Whether the actual data can be transmitted may be determined in accordance with proportions among the emotion statuses of the receivers using the N reception terminals 112. For example, in a case where the proportions of positive states and negative states as the proportions among the emotion statuses of the receivers using the N reception terminals 112 are 50% and 50% (or where the proportion of positive states is 50% or lower), the determining unit 234 determines that the actual data is not to be transmitted. In a case where the proportions of positive states and negative states are 60% and 40% (or where the proportion of positive states is higher than 50%), on the other hand, the determining unit 234 determines that the actual data can be transmitted.

In a case where the emotion statuses of all the receivers are not the same even after a predetermined period of time has passed, the determining unit 234 may determine that the actual data is not to be transmitted.

In a case where the determination result indicates transmission permission, the determining unit 234 determines a method of transmitting the actual data. In a case where the actual data is mail, for example, the method of transmitting the actual data may be a method by which the actual data is immediately transmitted to the reception terminal 112. In a case where the determination result indicates transmission prohibition, on the other hand, the determining unit 234 determines a method of rejecting the actual data. In a case where the actual data is mail, for example, the method of rejecting the actual data may be a method by which the actual data is held in the storage unit 233 or the like.

The determining unit 234 further generates feedback information based on the determination result. Under the control of the communication control unit 231, the feedback information is transmitted from the communication unit 221 to the transmission terminal 111 via the network 114.

Information is transmitted and received among the transmission terminal 111, the reception terminal 112, and the server 213, as the communication unit 125 is controlled by the communication control unit 132, the communication unit 141 is controlled by the communication control unit 151, or the communication unit 221 is controlled by the communication control unit 231.

[Transmission Process]

The flow of the series of procedures to be carried out by the transmission terminal 111 in the information processing system 201 having the above configuration to transmit actual data and the like to the server 113 (hereinafter referred to as a transmission process) is basically the same as the flow of the transmission process performed by the transmission terminal 111 of the second embodiment. Therefore, explanation thereof is skipped herein.

[Management Process]

Next, the series of procedures to be carried out by the server 213 from the setting of emotion statuses of the respective receivers using the N reception terminals 112 to the transmission of created feedback text data to the transmission terminal 111 are described (hereinafter referred to as the management process).

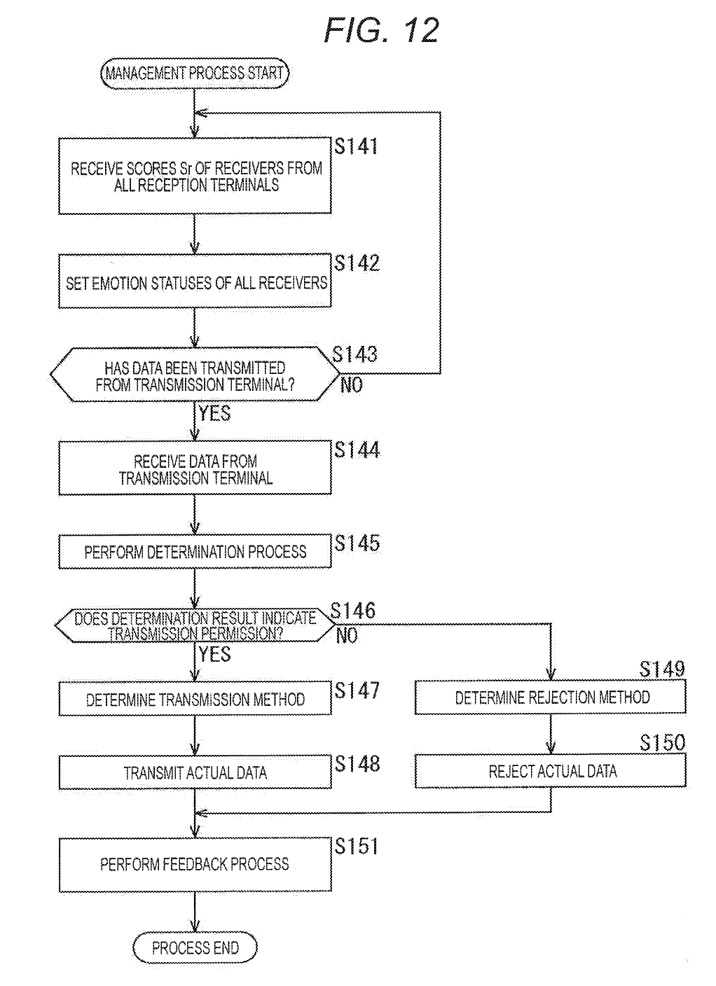

FIG. 12 is a flowchart for explaining the flow of the management process.

In step S141, the communication control unit 231 receives the scores Sr of the receivers from all the reception terminals 112.

In step S142, the status setting unit 232 sets the emotion statuses of all the receivers. For example, the status setting unit 232 evaluates the respective scores Sr of all the receivers, which have been received through the procedure of step S141, and sets positive states or negative states in accordance with the scores Sr. The set emotion statuses of all the receivers are stored into the storage unit 233.

In step S143, the communication control unit 231 determines whether data has been transmitted from the transmission terminal. Specifically, the communication control unit 231 determines whether actual data and accompanying information have been transmitted from the transmission terminal 111.

If data has not been transmitted from the transmission terminal 111, the result of the determination in step S143 is “NO”, and the process returns to step S141, so that the procedures thereafter are repeated. That is, the loop process of steps S141 through S143 is repeated until data is transmitted from the transmission terminal 111.

When data is transmitted from the transmission terminal 111 after that, the result of the determination in step S143 is “YES”, and the process moves on to step S144.

In step S144, the communication control unit 231 receives the data from the transmission terminal 111.

In step S145, the determining unit 234 performs the determination process. For example, the determining unit 234 determines whether the actual data can be transmitted to the reception terminal 112 based on the result of comparison among the emotion statuses of all the receivers, which have been set through the procedure of step S142. When having determined that the emotion statuses of all the receivers are the same, for example, the determining unit 234 outputs a determination result indicating permission of actual data transmission. When having determined that the emotion statuses of all the receivers are not the same, on the other hand, the determining unit 234 outputs a determination result indicating prohibition of actual data transmission.

In step S146, the determining unit 234 determines whether the determination result indicates transmission permission.

If the determination result indicates transmission permission, the result of the determination in step S146 is “YES”, and the process moves on to step S147.

In step S147, the determining unit 147 determines a transmission method.

In step S148, the communication control unit 231 transmits the actual data to all the reception terminals 112. That is, the communication control unit 231 transmits the mail in accordance with the transmission method determined by the determining unit 234 through the procedure of step S147.

The process then moves on to step S151. The procedures of step S151 and the later steps will be described later.

If the determination result indicates presentation prohibition, on the other hand, the result of the determination in step S146 is “NO”, and the process moves on to step S149.

In step S149, the determining unit 234 determines a rejection method.

In step S150, the communication control unit 231 rejects the actual data. That is, the communication control unit 231 rejects the mail in accordance with the rejection method determined by the determining unit 234 through the procedure of step S149.

The process then moves on to step S151, and the determining unit 234 performs a feedback process, to transmit feedback information to the transmission terminal 111. The feedback process is basically the same as the flow of the feedback process shown in FIG. 7.

In a case where the determination result indicates transmission permission, for example, the determining unit 234 creates feedback text data to the effect that the contents of the mail represented by the actual data have been transmitted to the reception terminals 112. As a result, a feedback text, “Mail has been successfully transmitted.”, is created, for example. After that, the determining unit 234 transmits the created feedback text data to the transmission terminal 111 via the communication control unit 231.

In a case where the determination result indicates transmission prohibition, on the other hand, the determining unit 234 creates feedback text data to the effect that the contents of the mail represented by the actual data have not been transmitted to the reception terminals 112. As a result, feedback text data to the effect that “The users at the destinations are not up to it this time.”, “Not everyone feels like it.”, or “Transmission of mail to the users has been suspended.” is created, for example. After that, the determining unit 234 transmits the created feedback text data to the transmission terminal 111 via the communication control unit 231.

At this point, the feedback process in step S151 comes to an end, and the management process also comes to an end.

[Reception Process]

Next, the series of procedures to be carried out by the reception terminal 112 from the analysis of the receiver data to the output of the actual data are described (hereinafter referred to as the reception process).

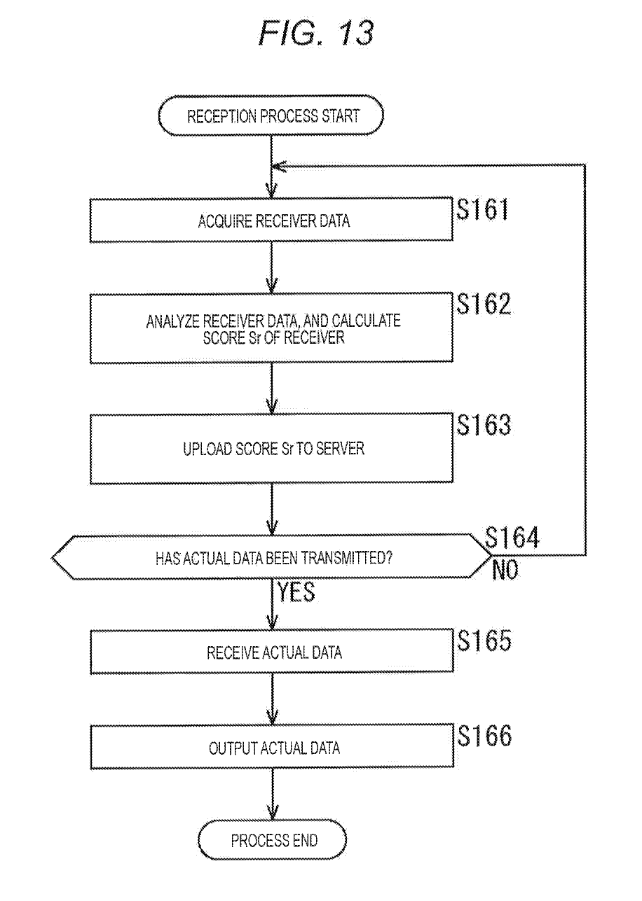

FIG. 13 is a flowchart for explaining the flow of the reception process.

In step S161, the data acquiring unit 152 acquires receiver data. Specifically, the data acquiring unit. 152 acquires the status information about the receiver that is output from the sensor unit 142, and the emotion information about the receiver that is set by the emotion setting unit 143.

In step S162, the analyzing unit 154 calculates a score Sr of the receiver by analyzing the receiver data acquired by the data acquiring unit 152 through the procedure of step S161. Here, the analysis method may be exactly the same as the method described in the first embodiment.

In step S163, the communication control unit 151 uploads the score Sr of the receiver calculated through the procedure of step S162 to the server 113.

In step S164, the communication control unit 151 determines whether actual data has been transmitted from the server 213.

If actual data has not been transmitted from the server 213, the result of the determination in step S164 is “NO”, and the process returns to step S161, so that the procedures thereafter are repeated. That is, the procedures of steps S161 through S164 are repeated until actual data is transmitted from the server 113.

When actual data is transmitted from the server 213 after that, the result of the determination in step S164 is “YES”, and the process moves on to step S165.

In step S165, the communication control unit 151 receives the actual data from the server 213.

In step S166, the output unit 145 outputs the actual data.

At this point, the reception process comes to an end.

As described above, in the information processing system 201 in which the server 213 determines whether actual data can be transmitted to the reception terminals 112, the timing to present the actual data can also be controlled in accordance with the emotions or states of the receivers. Accordingly, stress on the receivers can be reduced, and delight of the receivers can be increased.

Furthermore, as feedback information is transmitted from the server 213 to the transmission terminal 11, the sender can recognize whether the actual data has been transmitted at the reception terminals 112.

In the above described examples, the scores Sr of the receivers are calculated at the N respective reception terminals 112. However, the scores Sr of the respective receivers using the N reception terminals 112 may be calculated at the server.

[Example Configuration of an Information Processing System 301]

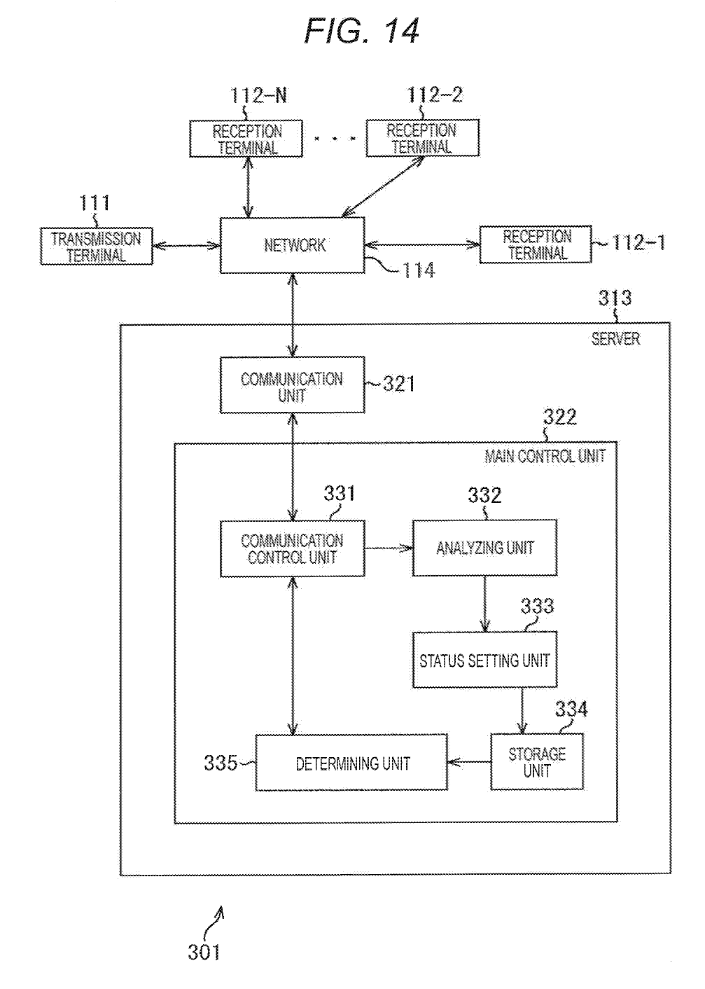

As described above, the status setting process is performed at the server 213 in the information processing system 201 shown in FIG. 11. However, the analysis process may also be performed on the server side. Referring now to FIG. 14, the information processing system in this case is described.

FIG. 14 is a block diagram showing an example configuration of the information processing system 301 to which the present technique is applied.

As shown in FIG. 14, the information processing system 301 is formed with a transmission terminal 111, reception terminals 112-1 through 112-N (N being an integer of 1 or greater), and a server 313 that are connected to one another via a network 114. In the information processing system 301 shown in FIG. 14, the structures and processes in the transmission terminal 111, the reception terminals 112-1 through 112-N, and the network 114 are basically the same as those in the transmission terminal 111, the reception terminal 112, and the network 114 of the information processing system 201 shown in FIG. 11. Therefore, in the following description of the information processing system 301, the same aspects as those of the information processing system 201 shown in FIG. 11 will not be described, and only different aspects will be described.

The server 313 manages respective kinds of data to be transmitted and received between the transmission terminal 111 and the reception terminals 112 via the network 114. The server 313 is designed to include a communication unit 321 and a main control unit 322.

Under the control of a communication control unit 331 described later, the communication unit 321 performs communication with the transmission terminal 111 and the reception terminals 112 via the network 114.

The main control unit 322 controls the entire operation of the server 313. A communication control unit 331, an analyzing unit 332, a status setting unit 333, a storage unit 334, and a determining unit 335 are provided in the main control unit 322.

The communication control unit 331 performs control so that the communication unit 321 receives actual data and accompanying information transmitted from the transmission terminal 111. The communication control unit 331 also performs control so that the communication unit 321 receives receiver data that is regularly uploaded from each of the N reception terminals 112, or the status information and the emotion information about the receivers.

The analyzing unit 332 calculates scores Sr of the receivers by analyzing the receiver data of the N respective reception terminals 112 (or the status information and the emotion information about the receivers), which has been received by the communication control unit 331. Since the method of calculating scores Sr of receivers has been described above, explanation thereof is not repeated herein.

The status setting unit 333 sets an emotion status in accordance with each of the scores Sr of the respective receivers using the N reception terminals 112, which have been calculated by the analyzing unit 332. Having substantially the same structure as the status setting unit 232 shown in FIG. 11, the status setting unit 333 is not described herein.

The storage unit 334 stores the emotion statuses of the respective receivers using the N reception terminals 112, which have been set by the status setting unit 333.

The determining unit 335 determines whether actual data received from the transmission terminal 111 can be transmitted to each of the reception terminals 112 based on the emotion statuses of the respective receivers using the N reception terminals 112, which have been set by the status setting unit 333. Having substantially the same structure as the determining unit 234 shown in FIG. 11, the determining unit 335 is not described herein.

[Transmission Process]

Next, a transmission process to be performed by the transmission terminal 111 in the information processing system 301 having the above structure, or the series of procedures to be carried out by the transmission terminal 111 to transmit actual data and the like to the server 313, is described (hereinafter referred to as the transmission process).

The flow of the transmission process to be performed by the transmission terminal 111 is basically the same as the flow of the transmission process performed by the transmission terminal 111 in the information processing system 201 shown in FIG. 11. Therefore, explanation thereof is skipped herein.

[Management Process]

Next, the series of procedures to be carried out by the server 313 from the reception of the receiver data of the N respective reception terminals 112 to the transmission of created feedback text data to the transmission terminal 111 are described (hereinafter referred to as the management process).

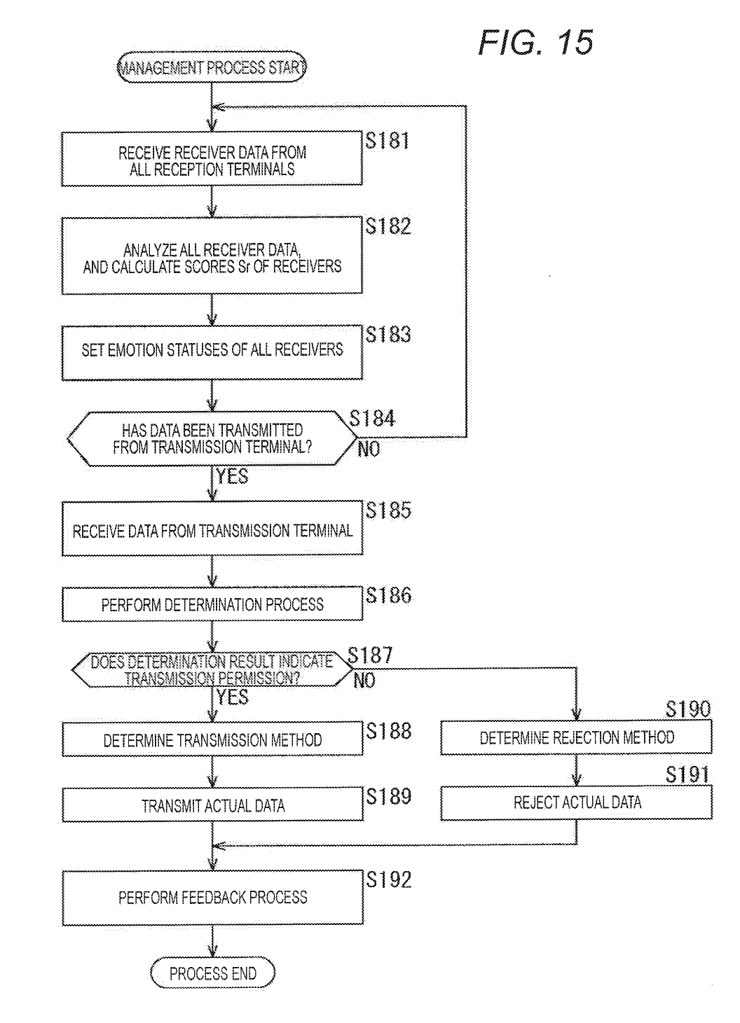

FIG. 15 is a flowchart for explaining the flow of the management process.

In step S181, the communication control unit 331 receives receiver data from all the reception terminals 112, or the status information and the emotion information about the receivers.

In step S182, the analyzing unit 332 calculates scores Sr of the receivers by analyzing all the receiver data.

In step S183, the status setting unit 333 sets the emotion statuses of all the receivers. Specifically, the status setting unit 333 sets positive states or negative states in accordance with the scores Sr of all the receivers calculated through the procedure of step S182. The set emotion statuses of all the receivers are stored into the storage unit 334. The process then moves on to step S184.

The flow of the procedures of steps S184 through S192 is basically the same as the flow of the procedures of steps S143 through S151 of FIG. 12. Therefore, explanation thereof is not repeated but is skipped herein.

At this point, the management process comes to an end.

[Reception Process]

Next, the series of procedures to be carried out by a reception terminal 112 from the transmission of the receiver data to the server 313, to the output of the actual data are described (hereinafter referred to as the reception process).

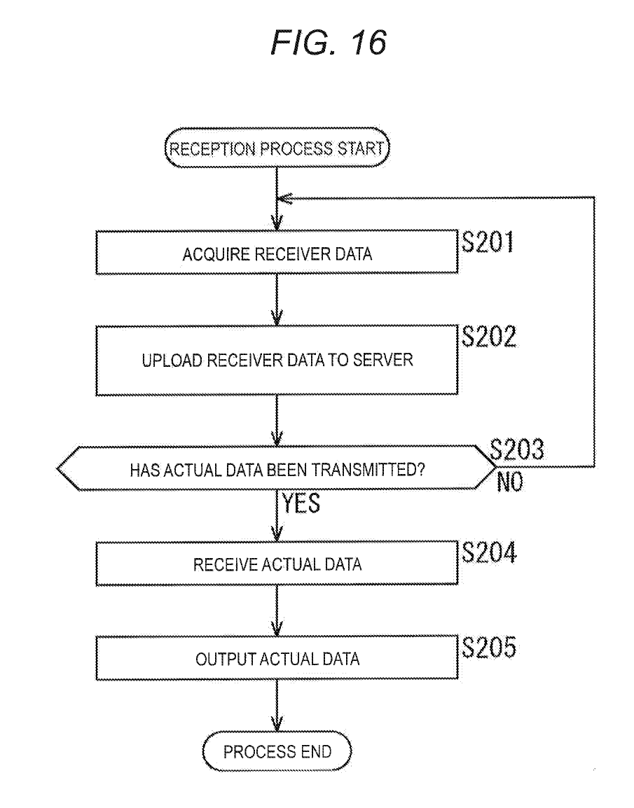

FIG. 16 is a flowchart for explaining the flow of the reception process.

In step S201, the data acquiring unit 152 acquires receiver data. Specifically, the data acquiring unit 152 acquires the status information about the receiver that is output from the sensor unit 142, and the emotion information about the receiver that is set by the emotion setting unit 143.

In step S202, the communication control unit 151 uploads the receiver data acquired through the procedure of step S201, or the status information and the emotion information about the receiver, to the server 313. The process then moves on to step S203.

The flow of the procedures of steps S203 through S205 is basically the same as the flow of the procedures of steps S164 through S166 of FIG. 13. Therefore, explanation thereof is not repeated but is skipped herein.

At this point, the reception process comes to an end.

As described above, a process to be carried out by a reception terminal 112 or the server may be carried out either a reception terminal 112 or the server, and the role allocation may be freely changed.

In a mobile terminal such as a portable telephone device, various operations are performed through buttons, a touch pad, or the like these days. Also, audio operations using speech recognition, such as inputs and searches with voice, are performed. For example, when the name of a certain person is voiced as in “Call Mr. A”, a phone call or mail can be transmitted to or received from the certain person. It is expected that development of voice recognition technology will enable people to perform various operations with voice, and recognize natural human behaviors through a microphone or the like in the future. In such a case, the emotion status of a receiver can be analyzed by using audio information obtained through speech recognition, and the present technique can be applied by using the result of the analysis.

The information processing system in such a case may have any configuration including the configuration of each of the above described embodiments, but has the configuration shown in FIG. 8 in the following example, for ease of explanation.

The following is a description of an example case where the emotion status of a receiver is recognized based on a history of operation instructions (hereinafter referred to as speech commands) issued through speech of the user of a reception terminal 112 or the like.

In this case, the receiver performs regular operations through speech commands or the like. In a case where an operation is performed through a speech command, the speech command is analyzed, and a score Sr of the receiver is output. The output score Sr of the receiver is then stored together with the history of speech command operations of the receiver. In a case where a speech command operation is regularly performed, a score Sr of the receiver is also regularly output and stored.

Ina case where data containing actual data is transmitted from the transmission terminal 111 to the reception terminal 112 or the server 113, the emotion status of the receiver immediately before the transmission is calculated based on the stored score Sr of the receiver. Actual data presentation at the reception terminal 112 is then controlled based on the calculated emotion status. In a case where the emotion status of the receiver indicates a positive state, for example, the actual data is presented at the reception terminal 112. In a case where the emotion status indicates a negative state, the actual data is rejected at the reception terminal 112. In a case where the emotion status of the receiver changes from a negative state to a positive state, the actual data is presented at the reception terminal 112 when the change in the emotion status occurs.

The score Sr of the receiver may be calculated based on a voice search word, a record of an everyday conversation, speech during a previous phone call, the environmental sound during an operation, or the like.

Although the actual data is mail in the above description, the same applies in a case where the actual data is audio data.

In a case where the actual data is audio data, the score Sr of the receiver is transmitted from the reception terminal 112 to the transmission terminal 11 in advance. At the transmission terminal 111, a check may be made to determine whether a telephone function can be used for the reception terminal 112 based on the score Sr of the receiver received from the reception terminal 112.

[Application of the Present Technique to a Program]

The above described series of processes can be performed by hardware, and can also be performed by software. When the series of processes are to be performed by software, the programs forming the software are installed into a computer. Here, the computer may be a computer incorporated into special-purpose hardware, or may be a general-purpose personal computer that can execute various kinds of functions as various kinds of programs are installed thereinto.

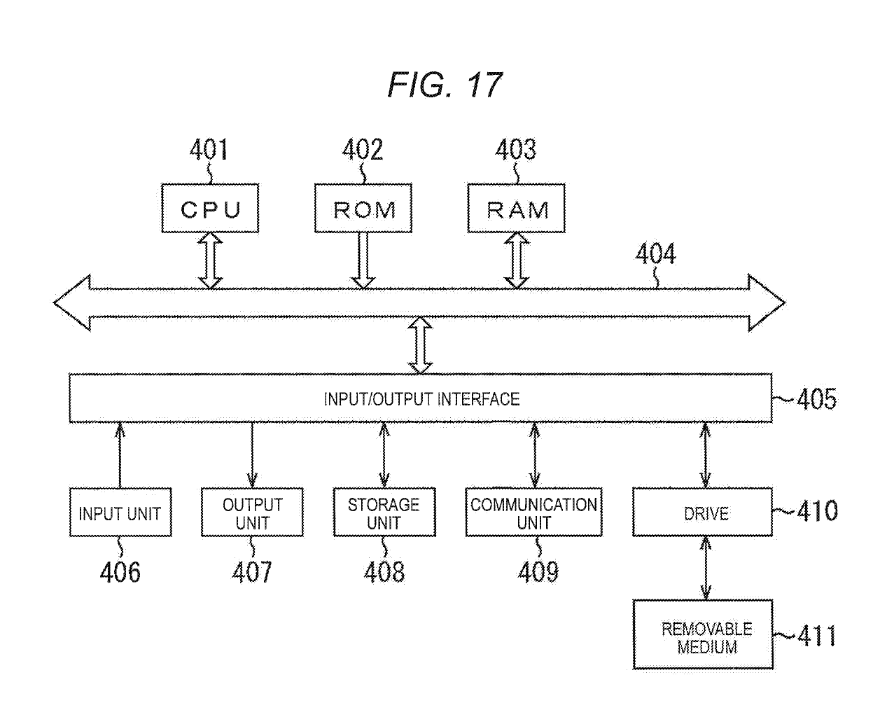

FIG. 17 is a block diagram showing an example structure of the hardware of a computer that performs the above described series of processes in accordance with a program.

In the computer, a CPU (Central Processing Unit) 401, a ROM (Read Only Memory) 402, and a RAM (Random Access Memory) 403 are connected to one another by a bus 404.

An input/output interface 405 is further connected to the bus 404. An input unit 406, an output unit 407, a storage unit 408, a communication unit 409, and a drive 410 are connected to the input/output interface 405.

The input unit 406 is formed with a keyboard, a mouse, a microphone, and the like. The output unit 407 is formed with a display, a speaker, and the like. The storage unit 408 is formed with a hard disk, a nonvolatile memory, or the like. The communication unit 409 is formed with a network interface or the like. The drive 410 drives a removable medium 411 such as a magnetic disk, an optical disk, a magnetooptical disk, or a semiconductor memory.

In the computer having the above described structure, the CPU 401 loads a program stored in the storage unit 408 into the RAM 403 via the input/output interface 405 and the bus 404, and executes the program, so that the above described series of processes are performed.

The program to be executed by the computer (the CPU 401) may be recorded on the removable medium 211 as a package medium to be provided, for example. Alternatively, the program can be provided via a wired or wireless transmission medium such as a local area network, the Internet, or digital satellite broadcasting.

In the computer, the program can be installed into the storage unit 408 via the input/output interface 405 when the removable medium 411 is mounted on the drive 410. The program can also be received by the communication unit 409 via a wired or wireless transmission medium, and be installed into the storage unit 408. Other than that, the program can be installed beforehand into the ROM 402 or the storage unit 408.

The program to be executed by the computer may be a program for performing processes in chronological order in accordance with the sequence described in this specification, or may be a program for performing processes in parallel or performing a process when necessary, such as when there is a call.

It should be noted that embodiments of the present technique are not limited to the above described embodiment, and various modifications may be made to it without departing from the scope of the present technique.

For example, the present technique can be embodied in a cloud computing structure in which one function is shared among apparatuses via a network, and processing is performed by the apparatuses cooperating with one another.

The respective steps described with reference to the above described flowcharts can be carried out by one apparatus or can be shared among apparatuses.

In a case where more than one process is included in one step, the processes included in the step can be performed by one apparatus or can be shared among apparatuses.

The present technique may also be embodied in the structures described below.

(1)

An information processing apparatus including:

a receiving unit that receives main information transmitted from a sender, and sender information related to an emotion or a state of the sender at the time of the transmission of the main information;

an acquiring unit that acquires receiver information related to an emotion or a state of a receiver;

an analyzing unit that analyzes the main information, the sender information, and the receiver information; and

a determining unit that determines whether the main information is to be presented based on a result of the analysis carried out by the analyzing unit.

(2)

The information processing apparatus of (1), wherein the determining unit determines a method of presenting the main information when having determined that the main information is to be presented, and determines a method of rejecting the main information when having determined that the main information is not to be presented.

(3)

The information processing apparatus of (1) or (2), wherein the presentation method includes at least one of a method concerning the timing to present the main information, and a method concerning the site for storing the main information.

(4)

The information processing apparatus of one of (1) through (3), wherein

the analyzing unit calculates a first score representing the sender information, and a second score representing the receiver information, and

the determining unit determines whether the main information is to be presented based on a comparison between the first score and the second score.

(5)

The information processing apparatus of one of (1) through (4), wherein the main information is electronic mail or sound.

(6)

The information processing apparatus of one of (1) through (5), wherein the sender information includes at least one of a result of detection performed by a sensor that detects a state of the sender, and an emotion status of the sender that is set based on an operation performed by the sender.

(7)

The information processing apparatus of one of (1) through (6), wherein the receiver information includes at least one of a result of detection performed by a sensor that detects a state of the receiver, and an emotion status of the receiver that is set based on an operation performed by the receiver.

(8)

The information processing apparatus of one of (1) through (7), wherein the result of the detection performed by the sensor includes physical information containing at least one of a body temperature, a heart rate, and a respiration rate, an image, or sound.

(9)

An information processing method for an information processing apparatus,

the information processing method including the steps of:

receiving main information transmitted from a sender, and sender information related to an emotion or a state of the sender at the time of the transmission of the main information;

acquiring receiver information related to an emotion or a state of a receiver;

analyzing the main information, the sender information, and the receiver information; and

determining whether the main information is to be presented based on a result of the analysis,

the steps being carried out by the information processing apparatus.

(10)

A program for causing a computer to function as:

a receiving unit that receives main information transmitted from a sender, and sender information related to an emotion or a state of the sender at the time of the transmission of the main information;

an acquiring unit that acquires receiver information related to an emotion or a state of a receiver;

an analyzing unit that analyzes the main information, the sender information, and the receiver information; and

a determining unit that determines whether the main information is to be presented based on a result of the analysis carried out by the analyzing unit.

(11)

A server including:

a receiving unit that receives main information transmitted from a sender, sender information related to an emotion or a state of the sender at the time of the transmission of the main information, and pieces of receiver information related to emotions or states of receivers; and

a transmitting unit that transmits the main information, and the sender information and the pieces of receiver information as information for determining whether the main information is to be presented, to the respective receivers.

(12)

The server of (11), further including:

a status setting unit that sets emotion statuses of the respective receivers based on the pieces of receiver information; and

a determining unit that determines whether the main information is to be transmitted to the respective receivers based on the emotion statuses set by the status setting unit for the respective receivers,

wherein,

when the determining unit determines that the main information is to be transmitted, the transmitting unit does not transmit the sender information and the pieces of receiver information, and transmits only the main information to the receivers, and

when the determining unit determines that the main information is not to be transmitted, the transmitting unit does not transmit the main information, the sender information, and the pieces of receiver information.

(13)

The server of (11) or (12), wherein the determining unit determines a method of transmitting the main information to the receivers when having determined that the main information is to be transmitted, and determines a method of rejecting transmission of the main information to the receivers when having determined that the main information is not to be transmitted.

(14)

An information processing method for a server,

the information processing method including the steps of:

receiving main information transmitted from a sender, sender information related to an emotion or a state of the sender at the time of the transmission of the main information, and pieces of receiver information related to emotions or states of receivers; and

transmitting the main information, and the sender information and the pieces of receiver information as information for determining whether the main information is to be presented, to the respective receivers,

the steps being carried out by the server.

(15)

A program for causing a computer to function as:

a receiving unit that receives main information transmitted from a sender, sender information related to an emotion or a state of the sender at the time of the transmission of the main information, and pieces of receiver information related to emotions or states of receivers; and

a transmitting unit that transmits the main information, and the sender information and the pieces of receiver information as information for determining whether the main information is to be presented, to the respective receivers.

The present technique can be applied to an information processing apparatus that is operated by a user and exchanges information with another apparatus being operated by another user.

### REFERENCE SIGNS LIST

1 Information processing system
11 Transmission terminal
12 Reception terminal
21 Actual data input unit
22 Sensor unit
23 Emotion setting unit
24 Main control unit
25 Communication unit
31 Data acquiring unit
32 Communication control unit
41 Communication unit
42 Sensor unit
43 Emotion setting unit
44 Main control unit
45 Output unit
51 Communication control unit
52 Data acquiring unit
53 Storage unit
54 Analyzing unit
55 Determining unit
101 Information processing system
113 Server
114 Network
171 Communication unit
172 Main control unit
181 Communication control unit
182 Storage unit
201 Information processing system
213 Server
221 Communication unit
222 Main control unit
231 Communication control unit
232 Status setting unit
233 Storage unit
234 Determining unit
301 Information processing system
313 Server
321 Communication unit
322 Main control unit
331 Communication control unit
332 Analyzing unit
333 Status setting unit
334 Storage unit
335 Determining unit

1. An information processing apparatus comprising:
a receiving unit configured to receive main information transmitted from a sender, and sender information related to an emotion or a state of the sender at the time of the transmission of the main information;
an acquiring unit configured to acquire receiver information related to an emotion or a state of a receiver;
an analyzing unit configured to analyze the main information, the sender information, and the receiver information; and
a determining unit configured to determine whether the main information is to be presented based on a result of the analysis carried out by the analyzing unit.

2. The information processing apparatus according to claim 1, wherein the determining unit determines a method of presenting the main information when having determined that the main information is to be presented, and determines a method of rejecting the main information when having determined that the main information is not to be presented.

3. The information processing apparatus according to claim 2, wherein the presentation method includes at least one of a method concerning a timing to present the main information, and a method concerning a site for storing the main information.

4. The information processing apparatus according to claim 1, wherein
the analyzing unit calculates a first score representing the sender information, and a second score representing the receiver information, and
the determining unit determines whether the main information is to be presented based on a comparison between the first score and the second score.

5. The information processing apparatus according to claim 1, wherein the main information is electronic mail or sound.

6. The information processing apparatus according to claim 1, wherein the sender information includes at least one of a result of detection performed by a sensor that detects a state of the sender, and an emotion status of the sender that is set based on an operation performed by the sender.

7. The information processing apparatus according to claim 1, wherein the receiver information includes at least one of a result of detection performed by a sensor that detects a state of the receiver, and an emotion status of the receiver that is set based on an operation performed by the receiver.

8. The information processing apparatus according to claim 6, wherein the result of the detection performed by the sensor includes physical information containing at least one of a body temperature, a heart rate, and a respiration rate, an image, or sound.

9. An information processing method for an information processing apparatus,
the information processing method comprising the steps of:
receiving main information transmitted from a sender, and sender information related to an emotion or a state of the sender at the time of the transmission of the main information;
acquiring receiver information related to an emotion or a state of a receiver;
analyzing the main information, the sender information, and the receiver information; and
determining whether the main information is to be presented based on a result of the analysis,
the steps being carried out by the information processing apparatus.

10. A server comprising:
a receiving unit configured to receive main information transmitted from a sender, sender information related to an emotion or a state of the sender at the time of the transmission of the main information, and a plurality of pieces of receiver information related to emotions or states of a plurality of receivers; and
a transmitting unit configured to transmit the main information, and the sender information and the pieces of receiver information as information for determining whether the main information is to be presented, to the respective receivers.

11. The server according to claim 10, further comprising:
a status setting unit configured to set emotion statuses of the respective receivers based on the pieces of receiver information; and
a determining unit configured to determine whether the main information is to be transmitted to the respective receivers based on the emotion statuses set by the status setting unit for the respective receivers,
wherein,
when the determining unit determines that the main information is to be transmitted, the transmitting unit does not transmit the sender information and the pieces of receiver information, and transmits only the main information to the receivers, and
when the determining unit determines that the main information is not to be transmitted, the transmitting unit does not transmit the main information, the sender information, and the pieces of receiver information.

12. The server according to claim 11, wherein the determining unit determines a method of transmitting the main information to the receivers when having determined that the main information is to be transmitted, and determines a method of rejecting transmission of the main information to the receivers when having determined that the main information is not to be transmitted.

13. An information processing method for a server,
the information processing method comprising the steps of:
receiving main information transmitted from a sender, sender information related to an emotion or a state of the sender at the time of the transmission of the main information, and a plurality of pieces of receiver information related to emotions or states of a plurality of receivers; and
transmitting the main information, and the sender information and the pieces of receiver information as information for determining whether the main information is to be presented, to the respective receivers,
the steps being carried out by the server.

14. An information processing system comprising a transmission apparatus and a reception apparatus,
the transmission apparatus comprising:
a first communication unit configured to transmit main information and sender information related to an emotion or a state of a sender at the time of the transmission of the main information,
the reception apparatus comprising:
a second communication unit configured to receive the main information and the sender information transmitted from the transmission apparatus;
an acquiring unit configured to acquire receiver information related to an emotion or a state of a receiver;
an analyzing unit configured to analyze the main information, the sender information, and the receiver information; and
a determining unit configured to determine whether the main information is to be presented based on a result of the analysis carried out by the analyzing unit.

15. An information processing method for an information processing system including a transmission apparatus and a reception apparatus,
the information processing method implemented by the transmission apparatus comprising the step of
transmitting main information and sender information related to an emotion or a state of a sender at the time of the transmission of the main information,
the information processing method implemented by the reception apparatus comprising the steps of:
receiving the main information and the sender information transmitted from the transmission apparatus;
acquiring receiver information related to an emotion or a state of a receiver;
analyzing the main information, the sender information, and the receiver information; and
determining whether the main information is to be presented based on a result of the analysis.

16. An information processing system comprising a transmission apparatus, a plurality of reception apparatuses, and a server,
the transmission apparatus comprising
a first communication unit configured to transmit main information and sender information related to an emotion or a state of a sender at the time of the transmission of the main information,
the server comprising:
a receiving unit configured to receive the main information and the sender information transmitted from the transmission apparatus, and a plurality of pieces of receiver information related to emotions or states of a plurality of receivers, the pieces of receiver information being transmitted from the reception apparatuses; and
a transmitting unit configured to transmit the main information, the sender information, and the pieces of receiver information to the respective receivers,
each of the reception apparatuses comprising:
an acquiring unit configured to acquire the receiver information;
a second communication unit configured to receive the main information and the sender information transmitted from the server, and transmit the receiver information acquired by the acquiring unit to the server;
an analyzing unit configured to analyze the main information, the sender information, and the receiver information; and
a first determining unit configured to determine whether the main information is to be presented based on a result of the analysis carried out by the analyzing unit.

17. The information processing system according to claim 16, wherein
the server further comprises:
a status setting unit configured to set emotion statuses of the respective receivers based on the pieces of receiver information; and
a second determining unit configured to determine whether the main information is to be transmitted to the respective receivers based on the emotion statuses set by the status setting unit for the respective receivers,
when the determining unit determines that the main information is to be transmitted, the transmitting unit of the server does not transmit the sender information and the pieces of receiver information, and transmits only the main information to the respective receivers, and
when the determining unit determines that the main information is not to be transmitted, the transmitting unit of the server does not transmit the main information, the sender information, and the pieces of receiver information, and the reception apparatuses do not perform the process with the first determining unit.

18. An information processing method for an information processing system including a transmission apparatus, a plurality of reception apparatuses, and a server,
the information processing method implemented by the transmission apparatus comprising the step of
transmitting main information and sender information related to an emotion or a state of a sender at the time of the transmission of the main information,
the information processing method implemented by the server comprising the steps of:
receiving the main information and the sender information transmitted from the transmission apparatus, and a plurality of pieces of receiver information related to emotions or states of a plurality of receivers, the pieces of receiver information being transmitted from the reception apparatuses; and
transmitting the main information, the sender information, and the pieces of receiver information to the respective receivers,
the information processing method implemented by each of the reception apparatuses comprising the steps of:
acquiring the receiver information
receiving the main information and the sender information transmitted from the server, and transmitting the acquired receiver information to the server;
analyzing the main information, the sender information, and the receiver information; and
determining whether the main information is to be presented based on a result of the analysis.

19. The information processing apparatus according to claim 7, wherein the result of the detection performed by the sensor includes physical information containing at least one of a body temperature, a heart rate, and a respiration rate, an image, or sound.
